(19) United States
(12) Patent Application Publication
(10) Pub. No.: US 2026/0161130 A1
(43) Pub. Date: Jun. 11, 2026

(54) IMAGE FORMING APPARATUS

(71) Applicant: CANON KABUSHIKI KAISHA, Tokyo (JP)

(72) Inventors: KOHEI KOGUCHI, Tokyo (JP); TOMOYA TATEISHI, Kanagawa (JP); OSAMU SASAOKA, Kanagawa (JP)

(21) Appl. No.: 19/183,449

(22) Filed: Apr. 18, 2025

(30) Foreign Application Priority Data
Apr. 24, 2024 (JP) 2024-070505

(51) Int. Cl. G03G 21/16; G03G 15/08

(52) U.S. Cl. CPC G03G 21/1647; G03G 15/0875; G03G 21/1633; G03G 2215/068; G03G 2221/1633; G03G 2221/1654; G03G 2221/1657; G03G 2221/1684

(57) ABSTRACT

An image forming apparatus to which a cartridge that stores developer is removably attachable includes a photosensitive member, an exposure device, a rotatable rotary including a storage unit configured to store the developer supplied from the cartridge, and a developing member that forms a developer image on the photosensitive member using the developer stored in the storage unit, a moving device that moves the cartridge between an attachment position at which the cartridge is positioned inside the rotary and a displaced position at which the cartridge is positioned outside the rotary; and an intermediate transfer unit. When viewed in a vertical direction, the intermediate transfer unit, a portion of the rotary, and the exposure device overlap. When viewed in a displacement direction in which the cartridge moves from the attachment position to the displaced position, the intermediate transfer unit, the exposure device, and the portion of the rotary overlap.

### BACKGROUND

### Technical Field

The present disclosure relates to an image forming apparatus that forms an image on a recording material.

### Description of the Related Art

A known electrophotographic image forming apparatus uses a rotary developing method in which a color image is formed by rotating a rotary including a plurality of developing members. Japanese Patent Laid-Open No. 2007-183305 and Japanese Patent Laid-Open No. 2008-096852 describe an image forming apparatus including a rotary and a plurality of toner cartridges (toner containers). The rotary includes a plurality of developing rollers. The toner cartridges are removably attachable to the rotary.

### SUMMARY

The present disclosure provides a new type of image forming apparatus developed from the related art.

An embodiment of the present disclosure is as follows.

An image forming apparatus to which a cartridge that stores developer is removably attachable includes a photosensitive member; an exposure device that irradiates a surface of the photosensitive member with light to form an electrostatic latent image on the surface; a rotary that is rotatable and includes a storage unit configured to store the developer supplied from the cartridge, and a developing member that forms a developer image on the photosensitive member using the developer stored in the storage unit; a moving device that moves the cartridge between an attachment position at which the cartridge is positioned inside the rotary and a displaced position at which the cartridge is positioned outside the rotary; and an intermediate transfer unit to which the developer image on the photosensitive member is transferred. When viewed in a vertical direction, the intermediate transfer unit, a portion of the rotary, and the exposure device overlap. When viewed in a displacement direction in which the cartridge moves from the attachment position to the displaced position, the intermediate transfer unit, the exposure device, and the portion of the rotary overlap.

Further features of the present disclosure will become apparent from the following description of exemplary embodiments with reference to the attached drawings.

### BRIEF DESCRIPTION OF THE DRAWINGS

FIG. 1 is a schematic diagram of an image forming apparatus according to the first embodiment.

FIG. 2 is a block diagram of the image forming apparatus according to the first embodiment.

FIG. 3 is a schematic diagram illustrating a developing unit, a toner cartridge, and a tray according to the first embodiment.

FIGS. 4A and 4B are sectional views of the image forming apparatus according to the first embodiment.

FIG. 5 is a perspective view of a rotary body according to the first embodiment.

FIGS. 6A to 6C are perspective views of the image forming apparatus according to the first embodiment.

FIGS. 7A and 7B are sectional views of the image forming apparatus according to the first embodiment.

FIG. 8 illustrates the rotary body according to the first embodiment.

FIG. 9 illustrates the rotary body according to the first embodiment.

FIG. 10 illustrates the rotary body according to the first embodiment.

FIGS. 11A and 11B illustrate a structure related to a movement of the tray according to the first embodiment.

FIGS. 12A and 12B illustrate the structure related to the movement of the tray according to the first embodiment.

FIGS. 13A and 13B are sectional views illustrating the structure of the image forming apparatus according to the first embodiment.

FIG. 14 is a perspective view of an intermediate transfer unit, a cleaning unit, and a scanner according to the first embodiment.

FIG. 15 is a front view of the cleaning unit and the scanner according to the first embodiment.

FIGS. 16A and 16B illustrate a support structure for the scanner according to the first embodiment.

FIGS. 17A and 17B are sectional views illustrating the structures of image forming apparatuses according to first and second modifications.

FIG. 18 is a perspective view of the scanner and a toner cartridge according to the first embodiment.

FIG. 19 is a plan view of a passage section of the scanner according to the first embodiment.

FIG. 20 is a side view of the scanner and the toner cartridge according to the first embodiment.

FIG. 21 is a sectional view taken along line XXI, XXII-XXI, XXII in FIG. 20 according to the first embodiment.

FIG. 22 is a sectional view taken along line XXI, XXII-XXI, XXII in FIG. 20 according to a second embodiment.

FIG. 23 is a plan view of the intermediate transfer unit, the scanner, and a rotary according to the first embodiment.

FIG. 24 is a plan view of the intermediate transfer unit, the scanner, and the rotary according to the first embodiment.

### DESCRIPTION OF THE EMBODIMENTS

Embodiments of the present disclosure will now be described with reference to the drawings.

### First Embodiment

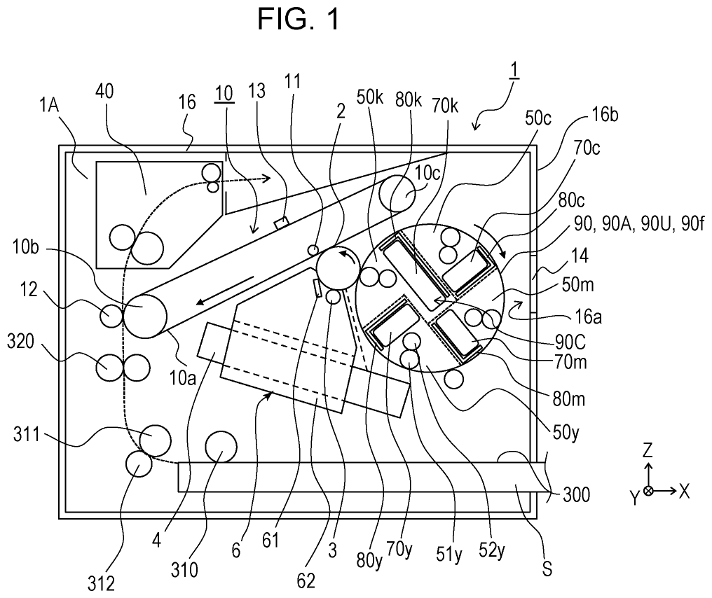

An image forming apparatus 1 according to a first embodiment will be described with reference to FIG. 1 to FIGS. 12A and 12B.

In the following description and drawings, a vertical direction of the image forming apparatus 1 installed on a horizontal surface is defined as a Z direction. A direction that crosses the Z direction and extends along a rotational axis 90C of a rotary body 90 described below (rotational axis direction of a rotary) is defined as a Y direction. A direction of a rotational axis of a photosensitive drum 2 (rotational axis direction of the photosensitive drum) is parallel to the direction of the rotational axis 90C of the rotary body 90, and is also the Y direction. A direction that crosses both the Z direction and the Y direction is defined as an X direction.

The X direction and the Y direction may be horizontal directions. The X direction, the Y direction, and the Z direction may be orthogonal to each other. As necessary, the sides toward which arrows X, Y, and Z point in each figure are expressed as +X, +Y, and +Z sides, respectively, and the sides opposite thereto are expressed −X, −Y, and −Z sides.

### Overall Structure of Image Forming Apparatus

The overall structure of the image forming apparatus 1 will now be described. The image forming apparatus 1 is a laser beam printer that forms an image on a sheet S by electrophotography. More specifically, the image forming apparatus 1 is a color laser beam printer including four developing units 50y, 50m, 50c, and 50k. The sheet S, which serves as a recording material (recording medium), may be various types of sheets of different sizes and materials including paper, such as plain paper and cardboard, plastic films, cloth, surface-treated sheets such as coated paper, and irregular-shaped sheets, such as envelopes and index tabs.

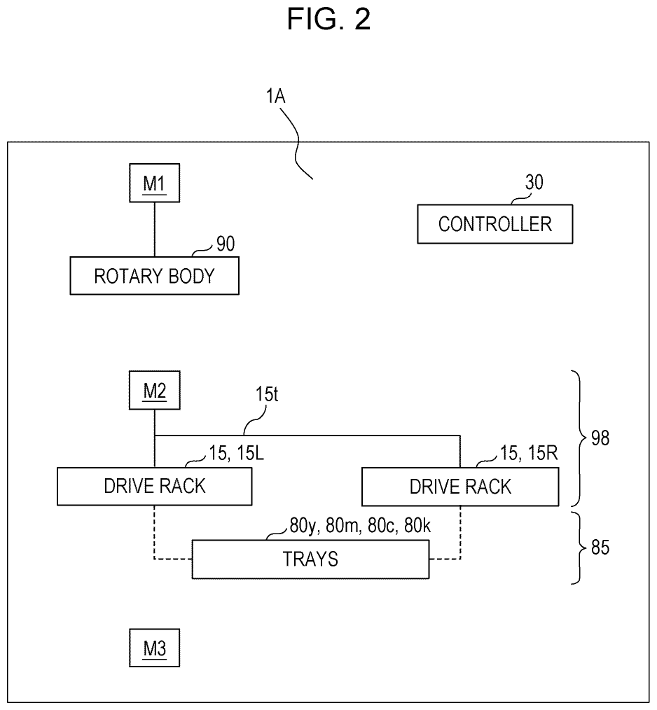

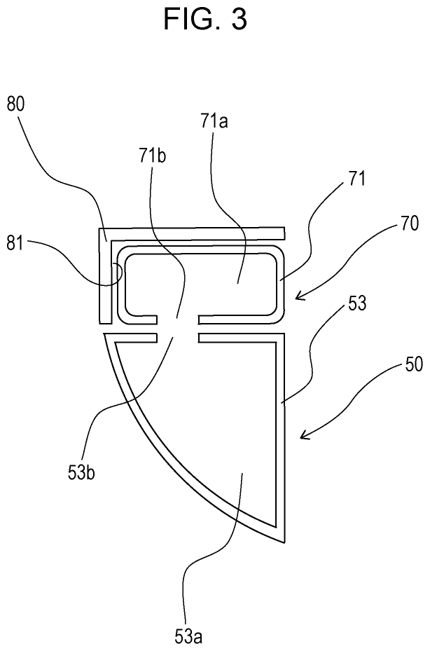

The schematic structure of the image forming apparatus 1 and an image forming operation will be described with reference to FIGS. 1, 2, and 3. FIG. 1 is a schematic diagram illustrating a cross-section of the image forming apparatus 1. FIG. 2 illustrates a drive source of the image forming apparatus 1. FIG. 3 is a conceptual diagram illustrating the structure for supplying toner from a toner cartridge 70 to a developing unit 50.

As illustrated in FIG. 1, the image forming apparatus 1 includes an image forming apparatus body (hereinafter referred to as an apparatus body) 1A and toner cartridges 70y, 70m, 70c, and 70k removably attachable to the apparatus body 1A. The apparatus body 1A of the present embodiment is a section of the image forming apparatus 1 excluding the toner cartridges 70y, 70m, 70c, and 70k.

The apparatus body 1A of the image forming apparatus 1 includes a drum-shaped (cylindrical) electrophotographic photosensitive member (hereinafter referred to as a photosensitive drum) 2 serving as an image carrier that carries an electrostatic latent image. A charging roller 3, a scanner 4 serving as an exposure device, and a cleaning unit 6 are arranged around the photosensitive drum 2.

The charging roller 3 is an example of a charger or a charging unit for uniformly charging the photosensitive drum 2. The scanner 4 is an example of an exposure member or an exposure unit that irradiates the photosensitive drum 2 with laser light corresponding to image information. The charged photosensitive drum 2 is irradiated with the laser light so that an electrostatic latent image is formed on a surface of the photosensitive drum 2. The cleaning unit 6 includes a cleaning blade 61 that removes toner remaining on the surface of the photosensitive drum 2 and a waste-toner-receiving unit 62 that receives the waste toner removed from the surface of the photosensitive drum 2 by the cleaning blade 61. The positional relationship between the cleaning unit 6 and the scanner 4 will be described below.

The apparatus body 1A further includes a sheet storage unit 300, a pick-up roller 310, a feed roller 311, a separation roller 312, a pair of transport rollers 320, a second transfer roller 12, a fixing device 40, and an intermediate transfer unit 10. The pick-up roller 310 is an example of a feeder or a feeding unit that feeds sheets S. The feed roller 311 and the separation roller 312 are an example of a separation transport unit that transports the sheets S one at a time while separating the sheets S from each other using friction. The second transfer roller 12 is an example of a transfer member or a transfer unit that transfers an image from an intermediate transfer belt 10a to each sheet S.

The intermediate transfer unit 10 includes the intermediate transfer belt 10a, a belt driving roller 10b, a tension roller 10c, a cleaning device 13, and a first transfer roller 11. The intermediate transfer belt 10a is an example of an intermediate transfer body that carries an image transferred thereto from the photosensitive drum 2 (first transfer) and that transports the image so that the image is transferred to the sheet S (second transfer). The intermediate transfer belt 10a is wrapped around the belt driving roller 10b and the tension roller 10c. The belt driving roller 10b is a driving member that is rotationally driven by a drive source to move the intermediate transfer belt 10a.

The apparatus body 1A further includes a rotary body (rotary, rotating body, developing device) 90 including developing units 50y, 50m, 50c, and 50k. As described below, in the present embodiment, trays (support members) 80y, 80m, 80c, and 80k are attached to the rotary body 90. The toner cartridges 70y, 70m, 70c, and 70k are removably attached to the trays 80y, 80m, 80c, and 80k, respectively.

In the following description, a plurality of members having similar functions may be distinguished from each other by ordinal numbers. For example, one of the toner cartridges 70y, 70m, 70c, and 70k may be referred to as a first toner cartridge, one of the remaining three as a second toner cartridge, one of the remaining two as a third toner cartridge, and the last one as a fourth toner cartridge.

Similarly, one of the trays 80y, 80m, 80c, and 80k may be referred to as a first tray, one of the remaining three as a second tray, one of the remaining two as a third tray, and the last one as a fourth tray. In other words, one of the trays 80y to 80k is an example of a first support member, another one of the trays 80y to 80k is an example of a second support member, still another one of the trays 80y to 80k is an example of a third support member, and the last one of the trays 80y to 80k is an example of a fourth support member. These ordinal numbers are used for convenience of description, and are interchangeable in principle.

Each of the developing units (first to fourth developing units) 50y, 50m, 50c, and 50k is an example of a developing part or a developing member that develops (visualizes) an electrostatic latent image formed on the photosensitive drum 2 into a toner image using toner of a color corresponding to the electrostatic latent image. The developing units 50y, 50m, 50c, and 50k develop electrostatic latent images formed on the photosensitive drum 2 using yellow toner, magenta toner, cyan toner, and black toner, respectively. The developing units 50y, 50m, 50c, and 50k may be arranged in an order different from that illustrated in FIG. 1.

The developing unit 50y includes a developing roller 51y, a supply roller 52y, and a developing blade. The developing roller 51y is a developer carrier that rotates while carrying toner serving as a developer and that supplies the toner to the photosensitive drum 2. The supply roller 52y is a supply member that is in contact with the developing roller 51y and supplies the toner to the developing roller 51. The developing blade is a regulation member that regulates the thickness of a toner layer carried by the developing roller 51y. The other developing units 50m, 50c, and 50k include developing rollers 51m, 51c, and 51k, supply rollers 52m, 52c, and 52k, and developing blades having similar structures.

The toner cartridges 70y, 70m, 70c, and 70k corresponding to the developing units 50y, 50m, 50c, and 50k, respectively, are attached to the rotary body 90. The toner cartridges 70y, 70m, 70c, and 70k store yellow toner, magenta toner, cyan toner, and black toner, respectively, as toners to be supplied to the developing units 50y, 50m, 50c, and 50k. One of the toners of the four colors may be referred to as first toner, one of the toners of the remaining three colors as second toner, one of the toners of the remaining two colors as third toner, and the toner of the last color as fourth toner. For example, the black toner may be regarded as an example of the first toner, and the magenta toner may be regarded as an example of the second toner. These ordinal numbers are used for convenience of description, and are interchangeable in principle.

The rotary body 90 includes a rotary frame 90f that supports the developing units 50y, 50m, 50c, and 50k. The developing units 50y, 50m, 50c, and 50k are supported by the rotary frame 90f, which is a rotatable support.

The trays 80y, 80m, 80c, and 80k are attached to the rotary body 90. A unit composed of the rotary body 90 and the trays 80y, 80m, 80c, and 80k may be referred to as a rotary unit 90U. In other words, the rotary unit 90U includes the rotary body 90 and the trays 80y, 80m, 80c, and 80k.

The toner cartridges 70y to 70k are removably held by the trays 80y to 80k. As described below, the trays 80y to 80k are supported such that the trays 80y to 80k are slidable to the outside of the rotary body 90. A unit composed of the rotary unit 90U and the toner cartridges 70y, 70m, 70c, and 70k may be referred to as a rotary assembly 90A. In other words, the rotary assembly 90A includes the rotary unit 90U and the toner cartridges 70y, 70m, 70c, and 70k.

As described below, the rotary body 90 is rotatable around the rotational axis (rotation center) 90C. The rotational axis 90C coincides with a rotational axis of the rotary frame 90f, the rotary unit 90U, and the rotary assembly 90A. In addition, the rotational axis 90C is substantially parallel to a rotational axis (rotation center) of the photosensitive drum 2.

The rotary body 90 is capable of rotating around the rotational axis 90C to a developing position in which one of the developing rollers 51y, 51m, 51c, and 51k faces the photosensitive drum 2. The position in which the developing roller 51y faces the photosensitive drum 2 is referred to as a yellow developing position. The position in which the developing roller 51m faces the photosensitive drum 2 is referred to as a magenta developing position. The position in which the developing roller 51c faces the photosensitive drum 2 is referred to as a cyan developing position. The position in which the developing roller 51k faces the photosensitive drum 2 is referred to as a black developing position. Thus, the rotary body 90 is capable of rotating around the rotational axis 90C to change the positions of the developing rollers 51y, 51m, 51c, and 51k relative to the photosensitive drum 2. The black developing position is an example of a first developing position in which the first developing roller (developing roller 51k) faces the photosensitive drum 2. The other developing positions are examples of a second developing position in which a second developing roller (developing rollers 51y to 51c) faces the photosensitive drum 2. The yellow, magenta, cyan, and black developing positions may be referred to as first to fourth developing positions. These ordinal numbers are used for convenience of description, and are interchangeable in principle.

As illustrated in FIG. 2, the apparatus body 1A includes motors M1, M2, and M3 as drive sources. As described below, the motor M1 supplies driving force for rotating the rotary body 90 around the rotational axis 90C. In other words, the motor M1 rotates the rotary assembly 90A and the rotary unit 90U around the rotational axis 90C.

The apparatus body 1A also includes a driving device 98 including the motor M2 and a transmission device. The transmission device includes drive racks 15L and 15R described below, which serve as drive gears, and a transmission unit 15t. The driving force of the motor M2 is transmitted to the drive racks 15L and 15R by the transmission unit 15t. In other words, the motor M2 is configured to drive the drive racks 15L and 15R, and moves the trays 80y, 80m, 80c, and 80k relative to the rotary body 90 by using the drive racks 15L and 15R.

The motor M3 drives members other than the members driven by the motors M1 and M2. For example, the motor M3 drives the photosensitive drum 2, the developing units 50y, 50m, 50c, and 50k, the pick-up roller 310, the feed roller 311, the pair of transport rollers 320, the second transfer roller 12, the belt driving roller 10b, and the fixing device 40.

The members driven by the motors M1, M2, and M3 may be changed as appropriate. The functions of any two or all three of the motors M1, M2, and M3 may be provided by a single motor. Also, a drive source other than the motors M1, M2, and M3 may be additionally provided.

The apparatus body 1A also includes a controller 30 as a control unit for controlling the operations of the image forming apparatus 1. The controller 30 includes a CPU that executes programs and a storage unit, such as a ROM or a RAM. The CPU reads the programs stored in the storage unit and executes the programs to control the operations of actuators, such as the motors M1, M2, and M3, included in the image forming apparatus 1. The storage unit includes non-volatile and volatile storage media and serves as a space for storing the programs and data and a work space when the CPU executes the programs. The functions of the controller 30 described below may be provided through an independent hardware unit, such as an ASIC, installed in a circuit in the controller 30.

The indices y, m, c, and k of the reference signs of the developing units 50y, 50m, 50c, and 50k, the toner cartridges 70y, 70m, 70c, and 70k, the trays 80y, 80m, 80c, and 80k, and other components represent the toner colors. The developing units 50y, 50m, 50c, and 50k have the same basic structure and function. The toner cartridges 70y, 70m, 70c, and 70k have the same basic structure and function. The trays 80y, 80m, 80c, and 80k have the same basic structure and function. Therefore, when these components do not need to be distinguished from each other, the indices y, m, c, and k are omitted, and each component is described as any one of the four units, four cartridges, or four trays. When the four units, four cartridges, or four trays are to be distinguished from each other, one of the indices y, m, c, and k is used to identify each item of the four units, four cartridges, or four trays being described.

As illustrated in FIG. 3, each toner cartridge 70 includes a toner frame 71. The toner frame 71 has a toner storage unit 71a that stores toner and a discharge opening 71b that communicates with the toner storage unit 71a.

Each developing unit 50 includes a developing frame (storage frame) 53. The developing frame 53 has a developing-device storage unit 53a (storage unit) and a receiving opening 53b that communicates with the developing-device storage unit (toner supply chamber) 53a. Thus, rotary body 90 includes a developing frame 53y, a developing frame 53m, a developing frame 53c, and a developing frame 53k. In other words, the rotary body 90 includes a first developing chamber, a second developing chamber, a third developing chamber, and a fourth developing chamber. Although each developing unit 50 includes the developing roller 51 and the supply roller 52 as described above, these members are not illustrated in FIG. 3.

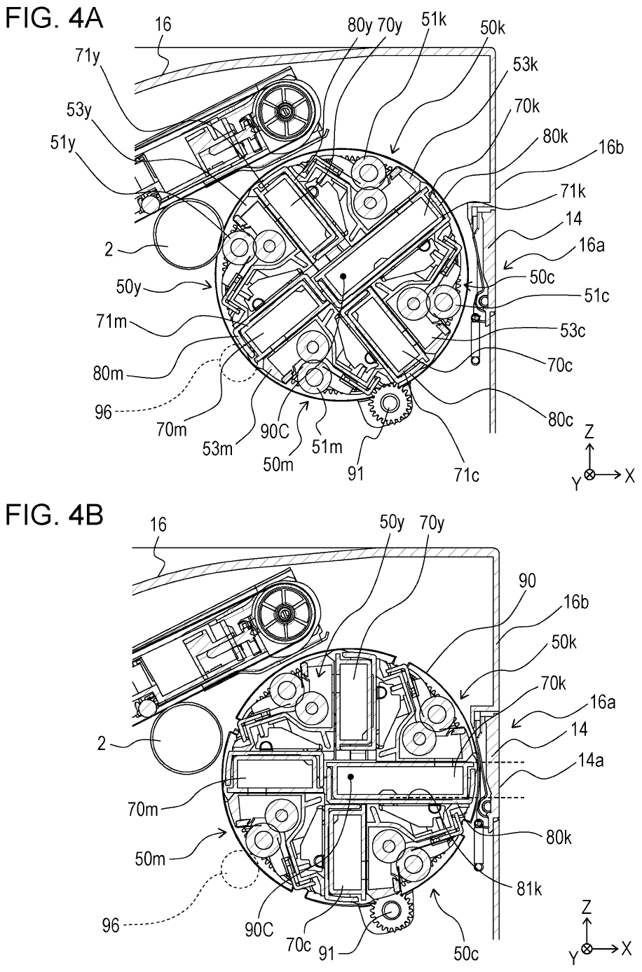

The developing roller 51k included in the developing unit 50k is an example of a first developing roller. The developing roller 51m included in the developing unit 50m is an example of a second developing roller. A developing frame 53k (FIG. 4A) of the developing unit 50k including the developing-device storage unit 53a is an example of a first storage frame including a first storage unit. A developing frame 53m (FIG. 4A) of the developing unit 50m including the developing-device storage unit 53a is an example of a second storage frame including a second storage unit. The rotary body 90 is an example of a rotatable rotary including the first developing roller, the second developing roller, the first storage frame including the first storage unit, and the second storage frame including the second storage unit. In the present embodiment, the rotary body 90 includes first to fourth developing rollers and first to fourth storage frames.

As described below, each toner cartridge 70 is movable relative to the corresponding developing frame 53 between an attachment position and a displaced position that is displaced from the attachment position. When the toner cartridge 70 is at the attachment position relative to the developing frame 53, the discharge opening 71b faces the receiving opening 53b. In other words, the toner storage unit 71a of the toner cartridge 70 and the developing-device storage unit 53a of the developing unit 50 communicate with each other through the discharge opening 71b and the receiving opening 53b. When the toner is supplied from the toner cartridge 70 to the developing unit 50, at least a portion of the receiving opening 53b is positioned below at least a portion of the discharge opening 71b.

The toner stored in the toner storage unit 71a is discharged through the discharge opening 71b, and the toner discharged through the discharge opening 71b is received by the developing-device storage unit 53a through the receiving opening 53b. More specifically, in the rotary body 90, the first developing chamber receives first developer, the second developing chamber receives second developer, the third developing chamber receives third developer, and the fourth developing chamber receives fourth developer.

The toner stored in the storage unit 53a is supplied to the developing roller 51 by the supply roller 52. The toner stored in the toner storage unit 71a is supplied to the developing roller 51 along the above-described path.

The toner cartridge 70 may include a sealing member (not illustrated) that covers the discharge opening 71b (first sealing member). The developing unit 50 may include a sealing member (not illustrated) that covers the receiving opening 53b (second sealing member).

When the toner cartridge 70 is not attached to the developing unit 50, the discharge opening 71b and the receiving opening 53b may be covered with the respective sealing members to prevent the toner from flowing out through the discharge opening 71b and the receiving opening 53b.

### Image Forming Operation

The image forming operation according to the present embodiment will now be described. First, the photosensitive drum 2 is rotated in the direction shown by the arrow in FIG. 1 (counterclockwise) in synchronization with the intermediate transfer belt 10a. Then, the surface of the photosensitive drum 2 is uniformly charged by the charging roller 3.

When a color image is to be formed on a sheet S, as described below, the rotary body 90 rotates in the direction shown by the arrow in FIG. 1 (clockwise) while supporting the developing units 50y, 50m, 50c, and 50k. The developing rollers 51y, 51m, 51c, and 51k are moved to a developing position one at a time, and an electrophotographic process is repeatedly performed.

First, the scanner 4 emits laser light based on image data corresponding to a yellow image to form an electrostatic latent image corresponding to the yellow image on the surface of the photosensitive drum 2. While the electrostatic latent image is being formed, the motor M1 rotates the rotary body 90 until the rotary body 90 reaches the yellow developing position. When the rotary body 90 is in the yellow developing position, the developing roller 51y is at the developing position and develops the electrostatic latent image formed on the photosensitive drum 2 with yellow toner. Thus, each developing roller 51 (developing member) is a developing member that forms a developer image on the photosensitive drum 2 (photosensitive member).

In the present embodiment, each of the developing rollers 51y, 51m, 51c, and 51k is an elastic roller including a metal shaft covered with rubber. Each of the developing rollers 51y, 51m, 51c, and 51k develops the electrostatic latent image while being in contact with the photosensitive drum 2 at the developing position. In other words, the image forming apparatus 1 according to the present embodiment uses a contact developing method. Alternatively, however, each of the developing rollers 51y, 51m, 51c, and 51k may develop the electrostatic latent image while being spaced from the photosensitive drum 2 at the developing position. In other words, the image forming apparatus 1 may use a noncontact developing method.

After the yellow toner image is developed, the first transfer roller 11 disposed inside the intermediate transfer belt 10a transfers the yellow toner image on the photosensitive drum 2 to the intermediate transfer belt 10a in a first transfer process.

After that, the rotary body 90 is rotated to successively move the developing rollers 51m, 51c, and 51k to the developing position, so that toner images of respective colors are formed. More specifically, after the yellow toner image is formed on the intermediate transfer belt 10a, the rotary body 90 rotates to the magenta developing position, and a magenta toner image is formed on the intermediate transfer belt 10a. After the magenta toner image is formed on the intermediate transfer belt 10a, the rotary body 90 moves to the cyan developing position, and a cyan toner image is formed on the intermediate transfer belt 10a. After the cyan toner image is formed on the intermediate transfer belt 10a, the rotary body 90 rotates to the black developing position, and a black toner image is formed on the intermediate transfer belt 10a. After the black toner image is formed on the intermediate transfer belt 10a, the rotary body 90 rotates around the rotational axis 90C in the direction shown by the arrow in FIG. 1 (clockwise) and returns to the yellow developing position. An image of any color may be formed on the intermediate transfer belt 10a first. For example, a black toner image may be formed first.

The first transfer process is repeated so that the toner images of the four colors are superposed on the intermediate transfer belt 10a. Thus, a color image is formed on the intermediate transfer belt 10a. The second transfer roller 12 and the cleaning device 13 do not come into contact with the intermediate transfer belt 10a until the color image is formed on the intermediate transfer belt 10a.

The sheet S is supplied from the sheet storage unit 300 disposed at the bottom of the apparatus body 1A by the pick-up roller 310. The sheet S is separated from the other sheets S and fed to the pair of transport rollers 320 by the feed roller 311 and the separation roller 312. The sheet S fed to the pair of transport rollers 320 is transported to a transfer section (second transfer section), which is a nip portion between the intermediate transfer belt 10a and the second transfer roller 12. The color image on the intermediate transfer belt 10a is transferred to a surface of the transported sheet S (second transfer).

The sheet S to which the color image has been transferred is transported to the fixing device 40. The fixing device 40 applies heat and pressure to the sheet S to fix the image to the sheet S. The sheet S that has passed through the fixing device 40 is output to the outside of the image forming apparatus 1 as a product.

When a monochrome image is to be formed on a sheet S, the rotary body 90 is rotated to the black developing position. In this state, the photosensitive drum 2 is subjected to charging and exposure so that an electrostatic latent image is formed on the surface of the photosensitive drum 2, and then the developing roller 51k positioned at the developing position develops the electrostatic latent image using black toner. The black toner image is transferred to the intermediate transfer belt 10a in a first transfer process, and then to the sheet S in a second transfer process. Subsequent processes are the same as those in the case in which a color image is formed.

### Structure of Rotary

The structure of the rotary body 90 will be described with reference to FIGS. 1, 4A, 4B, and 5.

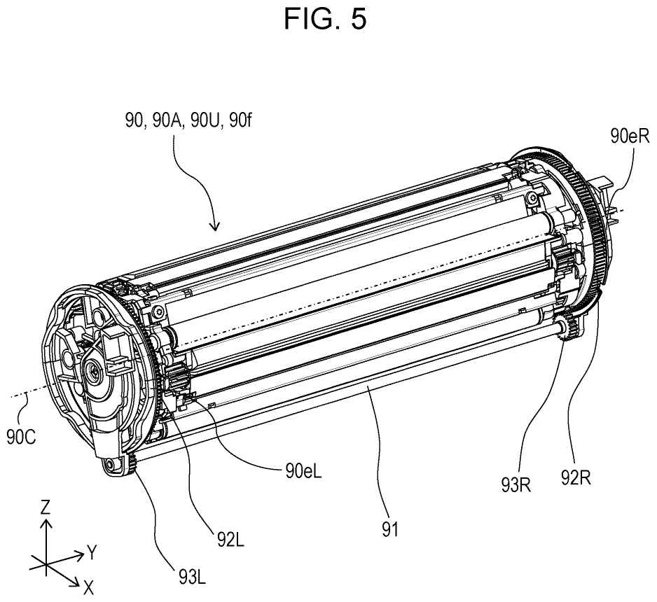

FIGS. 4A and 4B are sectional views of the rotary body 90 of the image forming apparatus 1 and a region surrounding the rotary body 90. FIGS. 4A and 4B are sectional views of the apparatus taken along an imaginary plane perpendicular to the rotational axis 90C of the rotary body 90. FIG. 5 is a perspective view of the rotary body 90.

As described above, the toner cartridges 70y to 70k are removably attachable to the rotary body 90. When the toners in the toner cartridges 70y to 70k run out, the toner cartridges 70y to 70k may be replaced so that toners can be supplied to the image forming apparatus 1.

As illustrated in FIG. 1, the apparatus body 1A includes a frame 16 that accommodates the rotary body 90.

The frame 16 is a main frame of the image forming apparatus 1 according to the present embodiment. The frame 16 is a housing (framework) of the apparatus body 1A constituted by frame members and outer members, and is substantially rectangular-parallelepiped-shaped in the present embodiment.

The frame 16 has an opening 16a. More specifically, the frame 16 has a side surface 16b that extends in a direction crossing a horizontal direction. The side surface 16b defines at least a portion of a +X-side outer surface of the apparatus body 1A. The opening 16a is formed in the side surface 16b. The side surface 16b is a side surface disposed downstream of an outlet in the apparatus body 1A in a direction in which the sheet S having an image formed thereon is output through the outlet. The user can access the sheet storage unit 300 to supply the sheets S or collect the sheets S output through the outlet from the side adjacent to the side surface 16b of the image forming apparatus 1. Therefore, the side surface 16b may be regarded as the front surface of the apparatus body 1A.

The toner cartridges 70y, 70m, 70c, and 70k are removably attachable to the rotary body 90 through the opening 16a. The toner cartridge 70k may be regarded as an example of a first toner cartridge that stores the toner to be supplied to the first developing roller (developing roller 51k) and that is removably attachable to a rotary (rotary body 90) through the opening 16a in the frame 16 of the apparatus body 1A. The toner cartridge 70m may be regarded as an example of a second toner cartridge that stores the toner to be supplied to the second developing roller (developing roller 51m) and that is removably attachable to the rotary (rotary body 90) through the opening 16a in the frame 16 of the apparatus body 1A.

In the present embodiment, the toner cartridges 70y, 70m, 70c, and 70k are supported by the trays 80y to 80k when attached to and removed from the rotary body 90 through the opening 16a.

In other words, the user can use the trays 80y to 80k to attach and remove the toner cartridges 70y to 70k to/from the rotary body 90.

The opening 16a is formed in the side surface 16b of the frame 16. In the present embodiment, the side surface 16b is substantially parallel to the rotational axis 90C of the rotary body 90. Therefore, when one of the toner cartridges 70 is to be replaced, the toner cartridge 70 to be placed is moved through the opening 16a in a direction that crosses (or is orthogonal to) the rotational axis 90C.

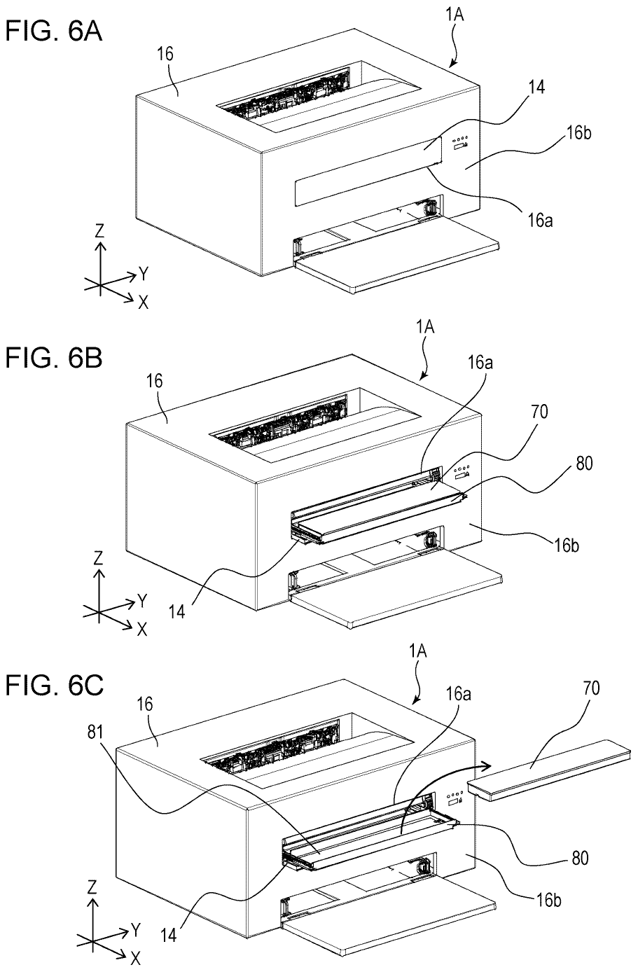

The image forming apparatus 1 includes a door 14 that covers the opening 16a in the frame 16. The door 14 is an opening-closing member movable between a closed position (see also FIG. 6A) at which the door 14 covers the opening 16a and an open position (see also FIGS. 6B and 6C) at which the door 14 is opened to expose the opening 16a.

As described above, in the present embodiment, the trays 80 are used to removably attach the toner cartridges 70 to the rotary body 90. Therefore, the toner cartridges 70 can be reliably attached to and removed from the rotary body 90.

More specifically, the user can replace the toner cartridges 70 by attaching and removing the toner cartridges 70 to/from the trays 80, which are movable relative to the rotary body 90 (that is, relative to the apparatus body 1A). If the user directly inserts and extracts a toner cartridge into/from the apparatus body to replace the toner cartridge, the user needs to insert the toner cartridge to a predetermined attachment position in the apparatus body. In the present embodiment, each tray 80 is movable while supporting the corresponding toner cartridge 70 to move the toner cartridge 70 to the attachment position. Therefore, the user can replace the toner cartridge 70 simply by placing the toner cartridge 70 on the tray 80. Thus, the operation is facilitated.

Each toner cartridge 70 has an elongated shape such that the longitudinal direction thereof is the Y direction, which is parallel to the rotational axis 90C of the rotary body 90. In other words, the dimension of the toner cartridge 70 in the longitudinal direction is greater than the height and width of the toner cartridge 70 in a cross-section orthogonal to the longitudinal direction. In the case where the toner cartridge 70 has such an elongated shape, when the opening 16a is formed in the side surface 16b of the frame 16 that is substantially parallel to the longitudinal direction (Y direction) of the toner cartridge 70, the toner cartridge 70 is only required to move a short distance to pass through the opening 16a. The toner cartridge 70 can be more easily replaced than when, for example, the toner cartridge 70 is inserted or extracted through an opening formed in a side surface on one side (+Y side or −Y side) of the frame 16 in the longitudinal direction of the toner cartridge 70.

The rotary body 90 is capable of rotating around the rotational axis 90C to replacement positions at which respective ones of the toner cartridges 70y to 70k are removable from the rotary body 90. The position in which the toner cartridge 70y is removable is referred to as a yellow replacement position. The position in which the toner cartridge 70m is removable is referred to as a magenta replacement position. The position in which the toner cartridge 70c is removable is referred to as a cyan replacement position.

The position in which the toner cartridge 70k is removable is referred to as a black replacement position.

The black replacement position is an example of a first replacement position in which the first toner cartridge is removable from the rotary body 90. The yellow, magenta, and cyan replacement positions are examples of a second replacement position in which the second toner cartridge is removable from the rotary body 90. The yellow, magenta, cyan, and black replacement positions may be referred to as first to fourth replacement positions. These ordinal numbers are used for convenience of description, and are interchangeable in principle.

The rotary body 90 is capable of rotating clockwise around the rotational axis 90C in FIG. 1 to successively move to the yellow, magenta, cyan, and black replacement positions. In the present embodiment, the rotary body 90 rotates clockwise around the rotational axis 90C in FIG. 1 to alternately reach a developing position and a replacement position. For example, in FIG. 1, the rotary body 90 is in the black developing position. When the rotary body 90 rotates clockwise from this state, the rotary body 90 successively reaches the cyan replacement position, the yellow developing position, the black replacement position, the magenta developing position, the yellow replacement position, the cyan developing position, and the magenta replacement position in that order. When the rotary body 90 rotates clockwise from the magenta replacement position, the rotary body 90 returns to the black developing position. Thus, the rotary body 90 is capable of rotating clockwise by one revolution (360°) or more.

FIG. 4A is a sectional view of the rotary body 90 in a developing position (more specifically, the yellow developing position). FIG. 4B is a sectional view of the rotary body 90 in a replacement position (more specifically, the black replacement position).

As illustrated in FIGS. 4A and 4B, the four trays 80y to 80k are attached to the rotary body 90. The trays 80y to 80k hold the respective toner cartridges 70y to 70k. FIGS. 4A and 4B illustrate a state in which the trays 80y to 80k are accommodated in the rotary body 90, which may be regarded as a state in which the toner cartridges 70y to 70k are attached to the developing units 50y, 50m, 50c, and 50k.

As described above, each toner cartridge 70 is movable relative to the developing frame 53 of the corresponding developing unit 50 between the attachment position and the displaced position that is displaced from the attachment position. In other words, the first toner cartridge (toner cartridge 70k) is movable relative to the first storage frame (developing frame 53k) between a first attachment position and a first displaced position. The second toner cartridge (toner cartridge 70m) is movable relative to the second storage frame (developing frame 53m) between a second attachment position and a second displaced position.

Referring to FIG. 3, when the toner cartridge 70 is at the attachment position relative to the developing frame 53, the discharge opening 71b and the receiving opening 53b face each other. In this state, the toner cartridge 70 supplies toner to the developing-device storage unit 53a through the receiving opening 53b (opening in the storage frame).

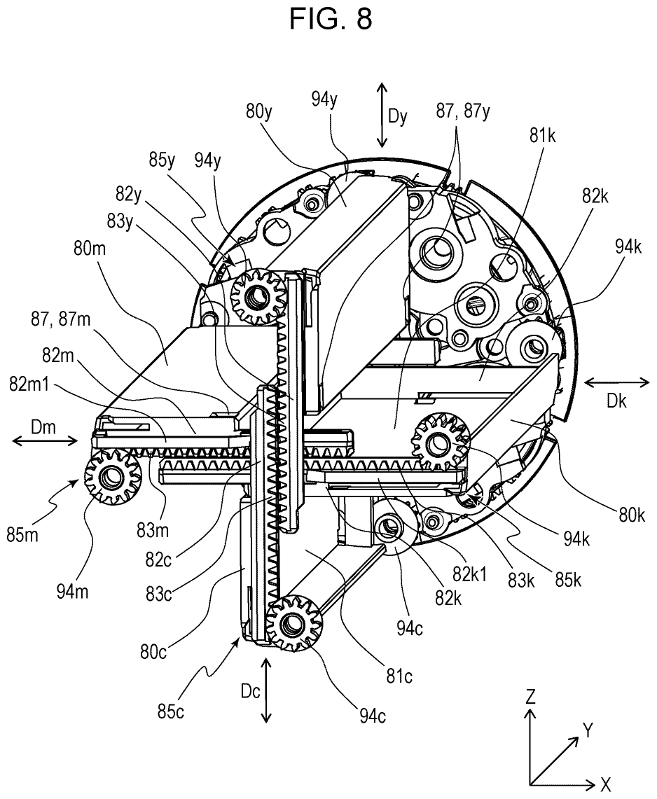

The apparatus body 1A includes moving devices 85 configured to move the respective toner cartridges 70 relative to the rotary body 90 (more specifically, relative to the developing frames 53 of the developing units 50) from the attachment position to the displaced position. The moving devices 85 will be described below with reference to FIG. 8 and other figures. In the present embodiment, the rotary body 90 is provided with moving devices 85y to 85k corresponding to the toner cartridges 70y to 70k. The trays 80y to 80k may be regarded as portions of the moving devices 85y to 85k.

In the present embodiment, the toner cartridge 70k storing black toner is larger in size and capable of storing a larger amount of toner than the toner cartridges 70y to 70c storing yellow toner, magenta toner, and cyan toner. In other words, the first toner cartridge is capable of storing a first amount of toner, the second toner cartridge is capable of storing a second amount of toner, and the first amount is greater than the second amount.

More specifically, the length of the black toner cartridge 70k in a first radial direction relative to the rotational axis 90C of the rotary body 90 is greater than the length of the magenta toner cartridge 70m in a second radial direction. Here, the first radial direction is a radial direction of the rotary body 90 (radial direction of an imaginary circle having the rotational axis 90C at the center) in which the toner cartridge 70k extends relative to the rotational axis 90C when viewed in the direction of the rotational axis 90C. The second radial direction is a radial direction of the rotary body 90 in which the toner cartridge 70m extends relative to the rotational axis 90C when viewed in the direction of the rotational axis 90C. Similarly, the length of the black toner cartridge 70k in the first radial direction is greater than the lengths of the toner cartridges 70y and 70c in radial directions corresponding to the toner cartridges 70y and 70c.

Therefore, the tray 80k that holds the black toner cartridge 70k is larger in size than the trays 80y to 80c that hold the other toner cartridges 70y, 70m, and 70c. In other words, the four toner cartridges 70y to 70k and the four trays 80y to 80k having different sizes are disposed in the rotary body 90. In other words, the toner cartridge 70k, which is an example of a first toner cartridge, and the toner cartridge 70y, which is an example of a second toner cartridge that is smaller in size than the first toner cartridge, are removably attachable to the rotary body 90. Accordingly, the tray 80k, which is an example of a first support member that supports the first toner cartridge, and the tray 80y, which is an example of a second support member that is smaller in size than the first support member, are provided in the rotary body 90. In addition, the toner cartridges 70m and 70c, which are examples of third and fourth toner cartridges that are smaller in size than the first toner cartridge, are removably attachable to the rotary body 90. Accordingly, the trays 80m and 80c, which are examples of third and fourth support members that are smaller in size than the first support member, are provided in the rotary body 90.

The operation of rotationally driving the rotary body 90 will be described with reference to FIG. 5. As illustrated in FIG. 5, disc gears 92L and 92R are formed at both ends of the rotary body 90. In addition, rotary drive gears 93L and 93R are connected to both ends of a swing shaft 91 to enable transmission of driving force. The driving force of the motor M1 is transmitted to the rotary drive gear 93R by a driving-force transmission mechanism. Then, the driving force is transmitted to the disc gears 92L and 92R by the rotary drive gears 93L and 93R to rotationally drive the rotary body 90. The rotary body 90 rotates clockwise around the rotational axis 90C in FIG. 1.

The rotary body 90 is supported such that the rotary body 90 is swingable about the swing shaft 91. The rotary body 90 is urged by an urging member (not illustrated) counterclockwise around the swing shaft 91 in FIGS. 4A and 4B. This direction may be regarded as a direction in which each of the developing rollers 51y to 51k approaches the photosensitive drum 2. As a result, when the rotary body 90 is in a developing position, one of the developing rollers 51y to 51k is in contact with the photosensitive drum 2.

As illustrated in FIG. 5, rotary cams 90eL and 90eR are provided at both ends of the rotary body 90. When the rotary body 90 rotates clockwise around the rotational axis 90C in FIGS. 4A and 4B, the rotary cams 90eL and 90eR come into contact with rollers 96 (FIGS. 4A and 4B) supported by the frame 16. Accordingly, the rotary body 90 swings clockwise about the swing shaft 91 in FIGS. 4A and 4B. This direction may be regarded as a direction in which each of the developing rollers 51y to 51k moves away from the photosensitive drum 2. In addition, this direction may also be regarded as a direction in which the rotary body 90 approaches the door 14 and the opening 16a in the frame 16.

Thus, when the rotary body 90 rotates from a developing position to a replacement position, the rotary body 90 swings about the swing shaft 91. When the rotary body 90 is in a replacement position, the developing roller 51 is separated from the photosensitive drum 2.

Referring to FIG. 4B, in the black replacement position, the toner cartridge 70k is stopped at a position at which the toner cartridge 70k faces the door 14 and the opening 16a formed in the side surface 16b of the apparatus body 1A. When the tray 80k in this state slides from the attachment position relative to the developing unit 50k to the outside of the rotary body 90, the user can replace the toner cartridge 70k.

### Operation of Replacing Toner Cartridge

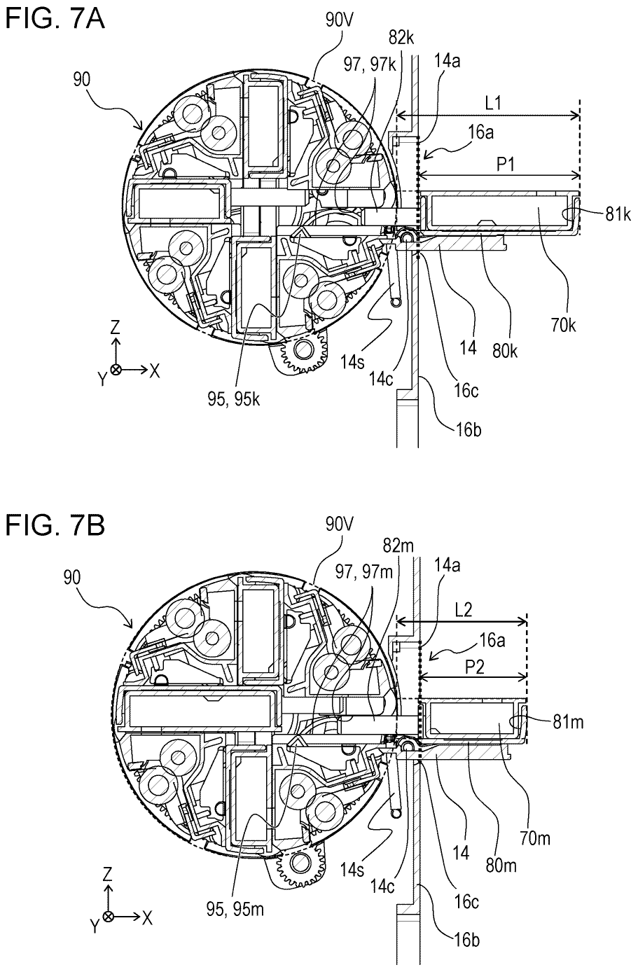

A toner-cartridge replacement operation will be described with reference to FIG. 4A, FIGS. 6A to 6C, and FIGS. 7A and 7B. FIGS. 6A to 6C are external views of the apparatus body 1A. FIGS. 7A and 7B are sectional views of a region around the rotary body 90 when a toner cartridge is replaced. FIGS. 7A and 7B are sectional views of the apparatus taken along an imaginary plane perpendicular to the rotational axis 90C of the rotary body 90.

FIG. 6A illustrates the appearance of the apparatus body 1A during the image forming operation and in a standby state. Here, “during the image forming operation” means during a period in which the image forming apparatus 1 feeds a sheet S, forms an image on the sheet S, and then outputs the sheet S as a product. The standby state is a state in which the image forming apparatus 1 is capable of starting the image forming operation in response to an image forming instruction (print instruction) and waits for the image forming instruction from the user. As illustrated in FIG. 6A, the door 14 is closed during the image forming operation and in the standby state.

FIG. 6B illustrates the appearance of the apparatus body 1A when a toner cartridge is being replaced. When a toner cartridge is being replaced, the door 14 is opened, and the tray 80 and the toner cartridge 70 are moved to the outside to the apparatus body 1A.

Each toner cartridge 70 is movable relative to the developing frame 53 of the corresponding developing unit 50 between the attachment position and the displaced position that is displaced from the attachment position. As illustrated in FIG. 3, when the toner cartridge 70 is at the attachment position relative to the developing frame 53, the discharge opening 71b and the receiving opening 53b face each other. As illustrated in FIGS. 4A and 4B, each toner cartridge 70 is at the attachment position while the rotary body 90 rotates around the rotational axis 90C to a developing position or a replacement position.

The operation of replacing a toner cartridge will now be described. First, the user instructs the controller 30 (FIG. 2) of the apparatus body 1A to perform the toner-cartridge replacement operation. The instruction to perform the toner-cartridge replacement operation is, for example, input through an operation panel (operation member) provided on the apparatus body 1A.

When the controller 30 receives the instruction to perform the toner-cartridge replacement operation, the rotary body 90 rotates to and stops at the replacement position for the toner cartridge 70 to be replaced (toner cartridge 70 in which the toner has run out). More specifically, the controller 30 rotates the rotary body 90 to the replacement position for the toner cartridge specified in the instruction to perform the toner-cartridge replacement operation (in FIG. 4B, to the black replacement position for replacing the black toner cartridge 70k). When the rotary body 90 is in the replacement position, the tray 80 supporting the toner cartridge 70 specified to be replaced faces the opening 16a in the frame 16 of the apparatus body 1A.

For example, in FIG. 4A, the rotary body 90 is in the yellow developing position in which the yellow developing roller 51y faces the photosensitive drum 2. In this state, the black toner cartridge 70k and the tray 80k do not need to face the opening 16a and the door 14. In other words, each toner cartridge 70 and the corresponding tray 80 do not need to face the opening 16a and the door 14 when the rotary body 90 is in a replacement position other than the replacement position for the toner cartridge 70 or a developing position. Therefore, the size of the opening 16a may be such that each toner cartridge 70 can individually pass through the opening 16a. When the rotary body 90 rotates clockwise in FIG. 4A by a predetermined angle from the yellow developing position, as illustrated in FIG. 4B, the black toner cartridge 70k and the tray 80k face the opening 16a and the door 14.

Here, the state in which “the tray 80 faces the opening 16a” means that the tray 80 is positioned to be movable to the outside of the apparatus body 1A through the opening 16a. In other words, when the tray 80 faces the opening 16a, a moving mechanism described below is capable of moving the tray 80 outward in a radial direction of the rotary body 90 so that the tray 80 and the toner cartridge 70 supported by the tray 80 project outward from the apparatus body 1A. In FIG. 4A, none of the trays 80y to 80k face the opening 16a. In FIG. 4B, only the black tray 80k faces the opening 16a, and the other trays 80y to 80c do not face the opening 16a.

When the rotary body 90 is in the replacement position, the motor M2 moves the tray 80 supporting the toner cartridge 70 to be replaced toward the outside of the apparatus body 1A.

Thus, the toner cartridge 70 to be replaced is moved relative to the rotary body 90 from the attachment position to the displaced position. As illustrated in FIGS. 6B and 6C and FIGS. 7A and 7B, the tray 80 and the toner cartridge 70 to be replaced that is supported by the tray 80 project to the outside of the apparatus body 1A through the opening 16a.

More specifically, the tray 80 is movable relative to the rotary body 90 between an accommodation position and a removal position. In other words, the first tray is movable relative to the rotary body 90 between an accommodation position (first position) and a removal position (second position). The second tray is movable relative to the rotary body 90 between an accommodation position (third position) and a removal position (fourth position). The accommodation position is a position at which the tray 80 is accommodated in the rotary body 90. The removal position is a position at which the tray 80 projects to the outside of the rotary body 90 and allows the toner cartridge 70 to be removed from the tray 80 (detachment position, replacement-enabled position). Examples of the accommodation position include the positions of the trays 80y to 80k in FIGS. 4A and 4B. Examples of the removal position include the positions of the tray 80 in FIGS. 6B and 6C, the tray 80k in FIG. 7A, and the tray 80m in FIG. 7B.

When each tray 80 is at the accommodation position, the toner cartridge 70 attached to the tray 80 is at the attachment position in the rotary body 90. When each tray 80 is at the removal position, the toner cartridge 70 attached to the tray 80 is at the displaced position outside the rotary body 90.

As illustrated in FIGS. 7A and 7B, the rotary body 90 includes projections 95 for holding the trays 80 at the accommodation position and holding the toner cartridges 70 at the attachment position. As illustrated in FIG. 8, the trays 80 have recesses 87 to which the projections 95 are fitted. FIGS. 7A and 7B illustrate projections 95k and 95m corresponding to the trays 80k and 80m, and FIG. 8 illustrates recesses 87y and 87m in the trays 80y and 80m. However, the projections 95 and the recesses 87 are provided for each of the trays 80y to 80k. The projections 95 may be urged in a direction in which the projections 95 engage with the recesses 87.

When the projections 95 are fitted to the recesses 87 in the trays 80, the trays 80 are restrained relative to the rotary frame 90f. Accordingly, when the rotary body 90 rotates, each tray 80 remains at the accommodation position, and the corresponding toner cartridge 70 is prevented from moving from the attachment position. When the tray 80 is moved between the accommodation position and the removal position by the moving device described below, the tray 80 moves the projections 95 so that the projections 95 are released from the recesses 87.

In the present embodiment, the door 14 is supported such that the door 14 is rotatable relative to the apparatus body 1A. As illustrated in FIG. 7A, the door 14 is urged in a direction from the open position toward the closed position by a spring 14s. The spring 14s is, for example, a tension spring and urges the door 14 to generate a counterclockwise moment around a support shaft 14c of the door 14 in FIGS. 7A and 7B.

The tray 80 pushes the door 14 to open the door 14 (state illustrated in FIG. 6B). This state may be regarded as a state in which the door 14 supports the tray 80. The door 14 supports at least a portion of the tray 80 that projects to the outside of the apparatus body 1A, so that the toner cartridge 70 can be reliably supported. In other words, when the first toner cartridge (toner cartridge 70k) is at the first displaced position, the opening-closing member (door 14) at the open position supports the first support member (tray 80k). When the second toner cartridge (toner cartridges 70y to 70c) is at the second displaced position, the opening-closing member (door 14) at the open position supports the second support member (trays 80y to 80c).

When the door 14 is at the open position, the door 14 is in contact with a portion of the frame 16 (for example, a lower edge 16c of the opening 16a) of the apparatus body 1A so that the door 14 does not rotate downward beyond the open position. When the tray 80 is pulled into the apparatus body 1A from the outside, the door 14 is caused to return to the closed position by the urging force of the spring 14s.

Each toner cartridge 70 is removably held by the corresponding tray 80. Therefore, as illustrated in FIG. 6C, the user can perform an operation of removing the toner cartridge 70 from the tray 80 and attaching a new toner cartridge 70 (replacing operation). When multiple toner cartridges 70 are to be replaced, the replacing operation may be performed by repeating the above-described process.

FIGS. 7A and 7B are sectional views of a region around the rotary body 90 when a toner cartridge is replaced.

FIG. 7A illustrates a case in which the black toner cartridge 70k is replaced. FIG. 7B illustrates a case in which the magenta toner cartridge 70m is replaced.

The image forming apparatus 1 includes the moving devices 85y, 85m, 85c, and 85k (FIG. 8) that respectively move the toner cartridges 70y, 70m, 70c, and 70k from the attachment position to the displaced position. When the indices are omitted, a “moving device 85” generally refers to any one of the moving devices 85y, 85m, 85c, and 85k. In the present embodiment, each moving device 85 may be regarded as including the corresponding tray 80. The moving device 85k including the tray 80k may be regarded an example of a first moving device including the first support member. The moving device 85m including tray 80m may be regarded as an example of a second moving device including the second support member.

Each tray 80 is connected to the rotary body 90 (supported by the rotary body 90) even when the corresponding toner cartridge 70 is at the displaced position. To allow the toner cartridge 70 to be easily removed from the rotary body 90, the toner cartridge 70 at the displaced position may project a long distance from the rotary body 90. Since the toner cartridge 70 is removably attachable to the rotary body 90 with the tray 80 provided therebetween, even when the toner cartridge 70 projects a long distance from the rotary body 90, the toner cartridge 70 may be reliably supported by the tray 80.

The direction in which each toner cartridge 70 moves from the attachment position to the displaced position is referred to as a displacement direction. In the present embodiment, the displacement direction of the toner cartridge 70 is a direction that crosses the direction of the rotational axis 90C (Y direction). Therefore, as illustrated in FIGS. 7A and 7B, when viewed in the direction of the rotational axis 90C (Y direction), the displacement direction of the toner cartridge 70 is a direction orthogonal to the direction of the rotational axis 90C (Y direction). The displacement direction of the toner cartridge 70 may also be regarded as a radially outward direction of the rotary body 90 (direction away from the rotational axis 90C).

Referring to FIGS. 7A and 7B, since the user removes the toner cartridge 70 from the rotary body 90, at least a portion of the toner cartridge 70 may project from the rotary body 90 when the toner cartridge 70 is removed. In the present embodiment, when the toner cartridge 70 is at the displaced position, the entire body of the toner cartridge 70 projects from the rotary body 90.

When the rotary body 90 rotates around the rotational axis 90C, the rotational trajectory of the rotary body 90 may be regarded as coinciding with a circumcircle of the rotary body 90 having the rotational axis 90C at the center (imaginary circle 90V shown by the dashed line in FIGS. 7A and 7B). When each toner cartridge 70 is at the displaced position, one-half or more of the length of the toner cartridge 70 in the displacement direction may be disposed outside the rotational trajectory of the rotary body 90. In other words, when the toner cartridge is at the displaced position as viewed in the rotational axis direction of the rotary, one-half or more of the overall length of the toner cartridge in the direction in which the toner cartridge moves from the attachment position to the displaced position may be disposed outside the rotational trajectory of the rotary. This applies to all of the toner cartridges 70 including the toner cartridge 70k, which is an example of the first cartridge, and the toner cartridge 70m, which is an example of the second cartridge. In addition, in the present embodiment, as illustrated in FIGS. 7A and 7B, when each toner cartridge 70 is at the displaced position, the entire body of the toner cartridge 70 may be outside the rotational trajectory (imaginary circle 90V) of the rotary body 90.

In addition, to allow the user to easily hold each toner cartridge 70, when the toner cartridge 70 is at the displaced position, at least a portion of the toner cartridge 70 is in an outside space of the image forming apparatus 1 (outside space of the apparatus body 1A). Here, the outside space is, for example, a space outside the image forming apparatus 1 (outside the apparatus body 1A) when the image forming apparatus 1 is used in, for example, the operation of forming an image on the sheet S.

In the present embodiment, an outer surface of the apparatus body 1A is formed of an outer surface of the frame 16. In other words, the outside space may also be regarded as a space outside the frame 16. Therefore, the state in which at least a portion of the toner cartridge 70 is in the outside space may also be regarded as a state in which at least a portion of the toner cartridge 70 projects outward from the frame 16 through the opening 16a in the frame 16 of the apparatus body 1A.

In the present embodiment, when the door 14 is at the closed position, the opening 16a in the frame 16 of the apparatus body 1A is covered by the door 14. An outer surface 14a of the door 14 in the closed position forms a portion of the outer surface of the apparatus body 1A. In this case, the outside space refers to a space outside the outer surface 14a of the door 14 at the closed position. In other words, assuming that the position of the outer surface 14a of the door 14 in the closed position is an exterior position, when the toner cartridge 70 is at the displaced position, at least a portion of the toner cartridge 70 projects outward from the apparatus body 1A beyond the exterior position.

In other words, at least a portion of the toner cartridge 70 is positioned in the space outside the apparatus body 1A defined when the door 14 is at the closed position. In addition, at least a portion of the toner cartridge 70 is positioned downstream of the exterior position in the displacement direction of the toner cartridge 70.

Assuming that the side surface 16b in which the opening 16a is formed is the front surface of the apparatus body 1A, when the toner cartridge 70 is at the displaced position, at least a portion of the toner cartridge 70 may be regarded as projecting forward from the front outer surface of the apparatus body 1A. In this case, the user can access the toner cartridge 70 from the front of the image forming apparatus and easily replace the toner cartridge 70.

When the toner cartridge 70 is at the displaced position, one-half or more of the length of the toner cartridge 70 in the displacement direction may be in the outside space. In other words, when the toner cartridge 70 is at the displaced position as viewed in the rotational axis direction of the rotary, one-half or more of the overall length of the toner cartridge in the direction in which the toner cartridge moves from the attachment position to the displaced position may be disposed outside the main frame. This applies to all of the toner cartridges 70 including the toner cartridge 70k, which as an example of the first cartridge, and the toner cartridge 70m, which as an example of the second cartridge. In addition, when the toner cartridge 70 is at the displaced position, the entire body of the toner cartridge 70 may be in the outside space. In the present embodiment, the outer surface 14a of the door 14 and the side surface 16b form the front outer surface of the apparatus body 1A. However, the structure of the door 14 is not limited to this. For example, the size of the door 14 may be such that the door 14 covers the entire side surface 16b. In this case, the outer surface 14a of the door 14 forms the front outer surface of the apparatus body 1A.

Each tray 80 includes a cartridge holder 81 that holds the corresponding toner cartridge 70 (see FIGS. 3 and 6C). The cartridge holder 81 is an attachment part to which the toner cartridge 70 is attached. When the tray 80 is at the removal position, the entire body of the cartridge holder 81 may be outside the rotational trajectory of the rotary body 90 in the displacement direction. When the tray 80 is at the removal position, one-half or more of the length of the cartridge holder 81 in the displacement direction may be in the outside space.

As described above, the toner cartridge 70k and the tray 80k are larger in size than the other toner cartridges 70y to 70c and the other trays 80y to 80c. Therefore, as FIGS. 7A and 7B, in the present embodiment, the amount by which each tray 80 is moved to replace the corresponding toner cartridge is changed in accordance with the size of the toner cartridge 70.

More specifically, as illustrated in FIG. 7A, the distance by which the tray 80k (first support member) moves from the accommodation position (first accommodation position) to the removal position (first removal position) is L1. The distance by which the tray 80m (second support member) moves from the accommodation position to the removal position (third removal position) is L2. Although FIG. 7B illustrates the movement of the toner cartridge 70m and the tray 80m, the distances by which the trays 80y and 80c are moved from the accommodation position to the removal position are also L2. Here, L1 is greater than L2. In other words, the distance by which the first support member moves to move the first toner cartridge from the first attachment position to the first displaced position is greater than the distance by which the second support member moves to move the second toner cartridge from the second attachment position to the second displaced position.

As illustrated in FIG. 7A, when the tray 80k is at the removal position and the toner cartridge 70k is at the displaced position, the toner cartridge 70k projects into the outside space from the outer surface of the apparatus body 1A by a distance P1. In the present embodiment, the tray 80k also projects into the outside space from the outer surface of the apparatus body 1A by the distance P1.

As illustrated in FIG. 7B, when the tray 80m is at the removal position and the toner cartridge 70m is at the displaced position, the toner cartridge 70m projects into the outside space from the outer surface of the apparatus body 1A by a distance P2. In the present embodiment, the tray 80m also projects into the outside space from the outer surface of the apparatus body 1A by the distance P2. The toner cartridges 70y and 70c also project into the outside space from the outer surface of the apparatus body 1A by the distance P2.

The above-described distance P1 is greater than the distance P2. More specifically, assume that the distance by which the first toner cartridge at the first displaced position projects from the opening 16a in the apparatus body 1A is a first distance (P1), and that the distance by which the second toner cartridge at the second displaced position projects from the opening 16a is a second distance (P2). In this case, the first distance is greater than the second distance.

The distance P2 by which the toner cartridges 70y to 70c, which are smaller in size than the toner cartridge 70k, project into the outside space at the displaced position may be less than the distance P1 by which the toner cartridge 70k projects into the outside space at the displaced position in consideration of strength. This is because of the following reasons. That is, when each toner cartridge 70 is at the displaced position, at least a portion of the toner cartridge 70 projects outward from the rotational trajectory of the rotary body 90, or into the outside space from the outer surface of the apparatus body 1A. At this time, the weight of the toner cartridge 70 is supported by the tray 80, which is supported by the rotary body 90 in a cantilever manner. Therefore, as the distance P2 by which the toner cartridges 70y to 70c project into the outside space at the displaced position is reduced, the load applied to the trays 80y to 80k and guiding portions 97 of the rotary body 90 that support the trays 80y to 80c is reduced. In addition, since the toner cartridges 70y to 70c are smaller in size than the toner cartridge 70k, even when the distance P2 is less than the distance P1, the cartridges on the trays 80y to 80c can still be easily replaced.

### Arrangement of Trays in Rotary

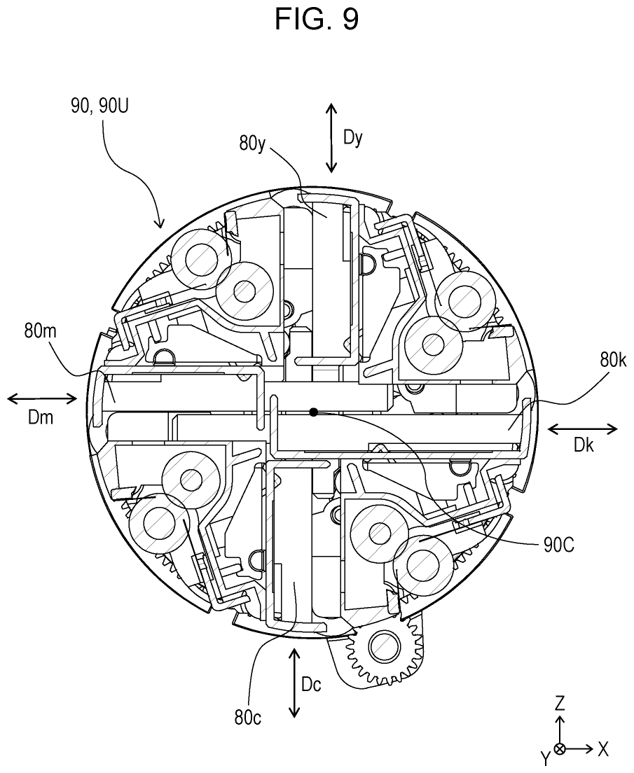

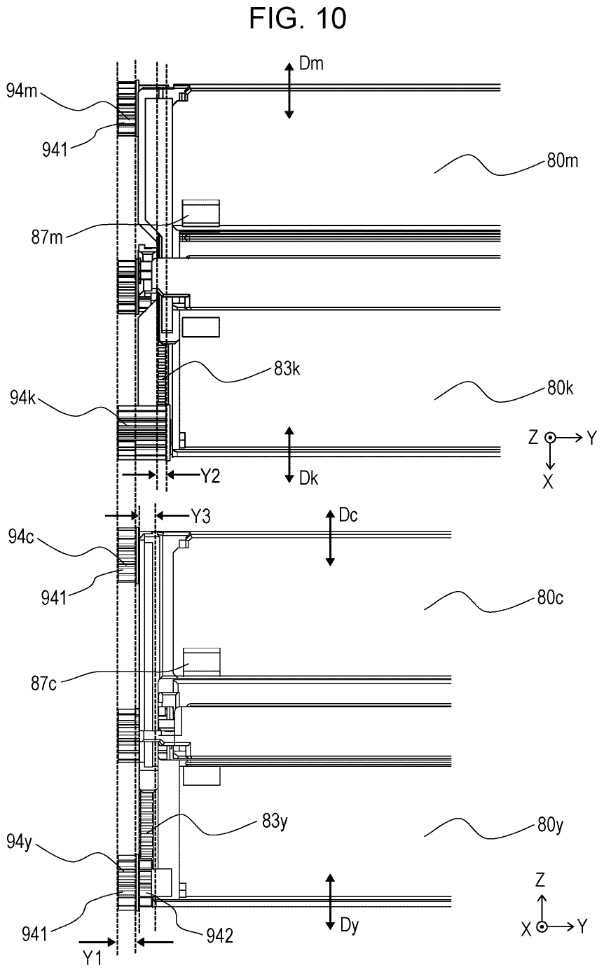

The arrangement of the trays 80y to 80k in the rotary body 90 will be described with reference to FIGS. 8, 9, and 10. FIG. 8 is a perspective view illustrating the arrangement of the trays 80y to 80k in the rotary body 90. FIG. 9 is a sectional view illustrating the arrangement of the trays 80y to 80k in the rotary body 90. FIG. 10 illustrates the arrangement of members of the trays 80y to 80k at one end in the Y direction. FIG. 9 is a sectional view of the rotary body 90 taken along an imaginary plane perpendicular to the rotational axis 90C of the rotary body 90. The upper half of FIG. 10 illustrates the rotary body 90 and the trays 80m and 80k in FIG. 8 viewed from the upper right (+Z side) in FIG. 8, and the lower half of FIG. 10 illustrates the rotary body 90 and the trays 80c and 80y in FIG. 8 viewed from the left (−X side) in FIG. 8.

As illustrated in FIG. 8, the trays 80y to 80k include the respective cartridge holders 81y to 81k and guided portions 82y to 82k.

The toner cartridges 70y to 70k are attached to the respective cartridge holders 81y to 81k. Each of the cartridge holders 81y to 81k accommodates at least a portion of one of the toner cartridges 70y to 70k that is attached thereto.

The guided portions 82y to 82k are provided at both ends of the respective trays 80y to 80k in the Y direction with the cartridge holders 81y to 81k disposed therebetween. The guided portions 82y to 82k are elongated members that extend in a direction orthogonal to the rotational axis of the rotary body 90.

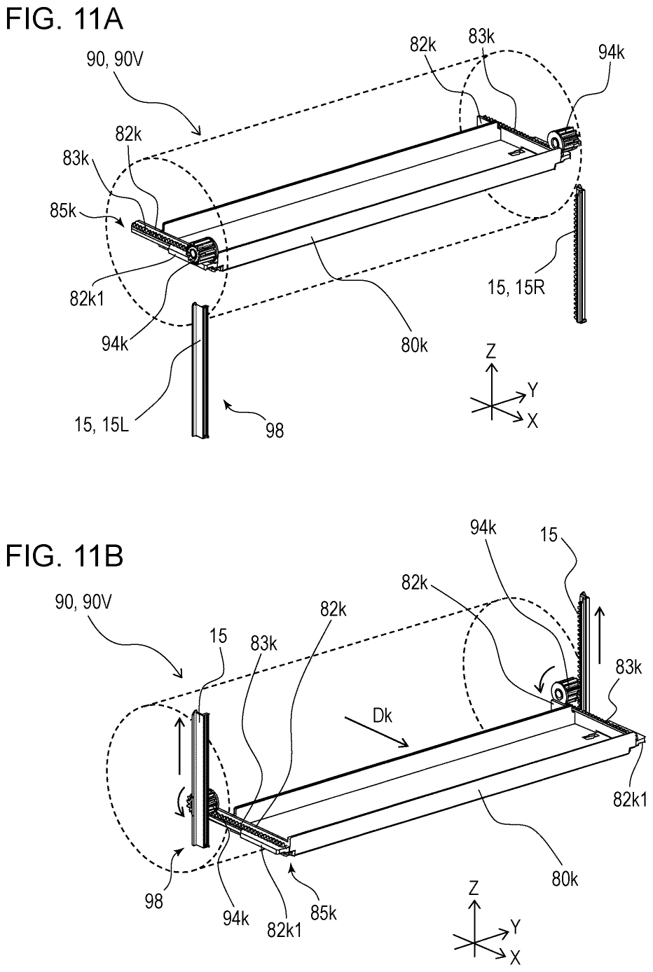

In the present embodiment, a reinforcing rib 82k1 is formed on a portion of each guided portion 82k in a movement direction Dk of the tray 80k, and a reinforcing rib 82m1 is formed on a portion of each guided portion 82m in a movement direction Dm of the tray 80m (see also FIGS. 11A and 11B). The reinforcing ribs 82k1 and 82m1 project outward in the Y direction from the guided portions 82k and 82m at both ends of the trays 80k and 80m in the Y direction, and have the shape of elongated ribs that extend in the movement directions Dk and Dm of the trays 80k and 80m. The reinforcing ribs 82k1 and 82m1 serve to increase the rigidity of the guided portions 82k and 82m.

In the present embodiment, the lengths of the reinforcing ribs 82m1 and 82k1 are limited to avoid interference with the guided portions 82y and 82c. However, when the reinforcing ribs 82m1 and 82k1 do not interfere with the guided portions 82y and 82c, the reinforcing ribs 82m1 and 82k1 may be formed to extend over the entire lengths of the guided portions 82m and 82k. The guided portions 82y and 82c may also be provided with reinforcing ribs. When the guided portions 82m and 82k are sufficiently rigid, the reinforcing ribs 82m1 and 82k1 may be omitted.

Rack parts 83y to 83k (rack gears) are formed on the guided portions 82y to 82k. In addition, pinion gears 94y to 94k are rotatably held in the rotary body 90. The pinion gears 94y to 94k mesh with the respective rack parts 83y to 83k to enable transmission of driving force.

The tray 80y is provided with one or more rack parts 83y. The rotary body 90 is provided with one or more pinion gears 94y corresponding to the one or more rack parts 83y. Similarly, the tray 80m, the tray 80c, and the tray 80k are respectively provided with one or more rack parts 83m, one or more rack parts 83c, and one or more rack parts 83k. The rotary body 90 is provided with one or more pinion gears 94m, one or more pinion gears 94c, and one or more pinion gears 94k respectively corresponding to the one or more rack parts 83m, the one or more rack parts 83c, and the one or more rack parts 83k.

The rack parts 83y to 83k and the pinion gears 94y to 94k are parts of the moving devices 85y to 85k configured to move the toner cartridges 70y to 70k from the attachment position to the displaced position. The rack parts 83y to 83k and the pinion gears 94y to 94k may be regarded as parts of driven devices driven by the driving device 98 of the apparatus body 1A.

The pinion gears 94y to 94k may be regarded as rotating bodies (rotating members) that rotate to move the trays 80y to 80k relative to the rotary body 90.

The moving devices 85y to 85k are driven by the driving device 98 of the apparatus body 1A. The pinion gears 94y to 94k and the rack parts 83y to 83k serve as driven units that allow the moving devices 85y to 85k of the rotary body 90 to receive driving force from the driving device 98 of the apparatus body 1A. The pinion gear 94k and the rack part 83k are examples of a first pinion gear and a first rack gear, respectively, that constitute at least a portion of a first driven unit included in the first moving device. The pinion gear 94m and the rack part 83m are examples of a second pinion gear and a second rack gear, respectively, that constitute at least a portion of a second driven unit included in the second moving device.

The rotary body 90 includes the guiding portions 97 (see FIGS. 7A and 7B) that engage with the respective guided portions 82y to 82k. FIG. 7A illustrates the guiding portion 97 (97k) that engages with the guided portion 82k of the tray 80k, and FIG. 7B illustrates the guiding portion 97 (97m) that engages with the guided portion 82m of the tray 80m. The rotary body 90 also includes similar guiding portions that engage with the guided portions 82y and 82c of the trays 80y and 80c. Although FIGS. 7A and 7B illustrate the guiding portions 97 provided at one side (+Y side) of the rotary body 90 in the Y direction, similar guiding portions 97 are provided at the other side (−Y side) of the rotary body 90 in the Y direction.

When each tray 80 moves between the accommodation position and the removal position, the guiding portions 97 remain engaged with the guided portions 82 in at least a portion of the range of movement to guide the movement direction of the tray 80. In the present embodiment, the guiding portions 97 remain engaged with the guided portions 82k over the entire range of movement of the tray 80k between the accommodation position and the removal position. In addition, in the present embodiment, the guiding portions 97 remain engaged with the guided portions 82m over the entire range of movement of the tray 80m between the accommodation position and the removal position.

Referring to FIGS. 8 and 9, the four trays 80y to 80k are disposed to overlap each other in the rotary body 90 as described in detail below.

When the pinion gears 94y to 94k rotate, the rack parts 83y to 83k and the trays 80y to 80k move relative to the rotary body 90. As illustrated in FIG. 9, the four trays 80y to 80k are arranged such that the movement directions thereof relative to the rotary body 90 are 90 degrees apart from each other. Therefore, the tray 80y and the tray 80c are slidable in substantially the same direction (parallel directions), and the tray 80m and the tray 80k are slidable in substantially the same direction (parallel directions). The movement directions in which the trays 80y to 80k slide are regulated by the above-described engagements between the guided portions 82y to 82k and the guiding portions 97.

The trays 80y to 80k move to the outside space through the opening 16a. When each of the trays 80y to 80k moves to the outside space through the opening 16a, each tray moves in substantially the same (parallel) direction.

As illustrated in FIG. 9, the region in which the tray 80k is disposed overlaps the region in which the tray 80y is disposed and the region in which the tray 80c is disposed in the movement direction Dk of the tray 80k. In addition, the region in which the tray 80k is disposed overlaps the rotational axis 90C of the rotary body 90 in the movement direction Dk of the tray 80k. In other words, the toner cartridge 70k held by the cartridge holder 81k of the tray 80k may be regarded as overlapping the rotational axis 90C of the rotary body 90 (FIG. 4B).

The region in which the tray 80m is disposed is shifted so as not to overlap the region in which the tray 80y is disposed and the region in which the tray 80c is disposed in the movement direction Dm of the tray 80m. In addition, the region in which the tray 80y is disposed is shifted so as not to overlap the region in which the tray 80m is disposed and the region in which the tray 80k is disposed in the movement direction Dy of the tray 80y. Similarly, the region in which the tray 80c is disposed is shifted so as not to overlap the region in which the tray 80m is disposed and the region in which the tray 80k is disposed in the movement direction Dc of the tray 80c.

The positional relationship between the trays 80 may be described as follows. That is, when viewed in the movement direction Dy of the tray 80y, the tray 80y overlaps the tray 80k, but does not overlap the tray 80m. When viewed in the movement direction Dm of the tray 80m, the tray 80m overlaps the tray 80k, but does not overlap the trays 80y and 80c. When viewed in the movement direction Dc of the tray 80c, the tray 80c overlaps the tray 80k, but does not overlap the tray 80m.

Here, the state in which two elements (members, components, units, or the like) overlap when viewed in a specific direction means that when the elements are projected onto an imaginary plane perpendicular to the specific direction, the projection region of one element and the projection region of the other element at least partially overlap.

As illustrated in FIGS. 8 and 10, the region in which the rack part 83m and the guided portion 82m are disposed and the region in which the rack part 83k and the guided portion 82k are disposed at least partially overlap in the direction of the rotational axis 90C (Y direction). In other words, in the present embodiment, the region in which the first rack gear (rack part 83k) is disposed and the region in which the second rack gear (rack part 83m) is disposed at least partially overlap in the rotational axis direction of the rotary (Y direction). Therefore, compared to when the rack part 83m and the guided portion 82m do not overlap the rack part 83k and the guided portion 82k, the rack parts 83m and 83k and the guided portions 82m and 82k may be disposed in a smaller space in the Y direction.

The region in which the rack part 83y and the guided portion 82y are disposed and the region in which the rack part 83c and the guided portion 82c are disposed at least partially overlap in the direction of the rotational axis 90C (Y direction). In other words, in the present embodiment, the region in which the third rack gear (rack part 83y) is disposed and the region in which the fourth rack gear (rack part 83c) is disposed at least partially overlap in the rotational axis direction of the rotary (Y direction). Therefore, compared to when the rack part 83y and the guided portion 82y do not overlap the rack part 83c and the guided portion 82c, the rack parts 83y and 83c and the guided portions 82y and 82c may be disposed in a smaller space in the Y direction.

The positions at which the rack parts (rack gears) 83 mesh with the respective pinion gears 94 will be described with reference to FIG. 10. The upper half of FIG. 10 illustrates the position at which the rack part 83k and the pinion gear 94k mesh with each other. The lower half of FIG. 10 illustrates the position at which the rack part 83y and the pinion gear 94y mesh with each other.

In a region Y1 illustrated in FIG. 10 along the direction of the rotational axis 90C of the rotary body 90 (Y direction), the driving force transmitted from the motor M2 (FIG. 2) serving as the drive source is transmitted to the pinion gears 94y to 94k through a transmission device described below. In a region Y2 along the Y direction in FIG. 10, the pinion gear 94k meshes with the rack part 83k to enable transmission of the driving force. In a region Y3 along the Y direction in FIG. 10, the pinion gear 94y meshes with the rack part 83y to enable transmission of the driving force. Similarly to the rack part 83k, the rack part 83m also meshes with the pinion gear 94m (FIG. 8) in the region Y2 to enable transmission of the driving force. Similarly to the rack part 83y, the rack part 83c also meshes with the pinion gear 94c (FIG. 8) in the region Y3 to enable transmission of the driving force.

The regions Y2 and Y3 are at different positions in the Y direction (shifted from each other in the Y direction). The region Y1 is at a position different from each of the regions Y2 and Y3 in the Y direction. In other words, the region Y1 is shifted from the regions Y2 and Y3 in the Y direction.

When the toner cartridges 70y and 70c are at the attachment position, the region in which the rack part 83y is disposed and the region in which the rack part 83c is disposed at least partially overlap in the movement direction of the rack part 83y (movement direction Dy of the tray 80y). In the present embodiment, the movement directions Dy and Dc of the trays 80y and 80c are substantially the same (parallel). Therefore, also in the movement direction Dc of the tray 80c, the region in which the rack part 83y is disposed and the region in which the rack part 83c is disposed at least partially overlap. Accordingly, when the toner cartridges 70y and 70c are at the attachment position, a tooth surface of the rack part 83y and a tooth surface of the rack part 83c face each other in the direction orthogonal to the movement directions Dy and Dc of the rack parts 83y and 83c (in the left-right direction in FIG. 8).

When the toner cartridges 70m and 70k are at the attachment position, the region in which the rack part 83m is disposed and the region in which the rack part 83k is disposed at least partially overlap in the movement direction of the rack part 83m (movement direction Dm of the tray 80m). In the present embodiment, the movement directions Dm and Dk of the trays 80m and 80k are substantially the same (parallel). Therefore, also in the movement direction Dk of the tray 80k, the region in which the rack part 83m is disposed and the region in which the rack part 83k is disposed at least partially overlap. Accordingly, when the toner cartridges 70m and 70k are at the attachment position, a tooth surface of the rack part 83m and a tooth surface of the rack part 83k face each other in the direction orthogonal to the movement directions Dm and Dk of the rack parts 83m and 83k (in the up-down direction in FIG. 8).

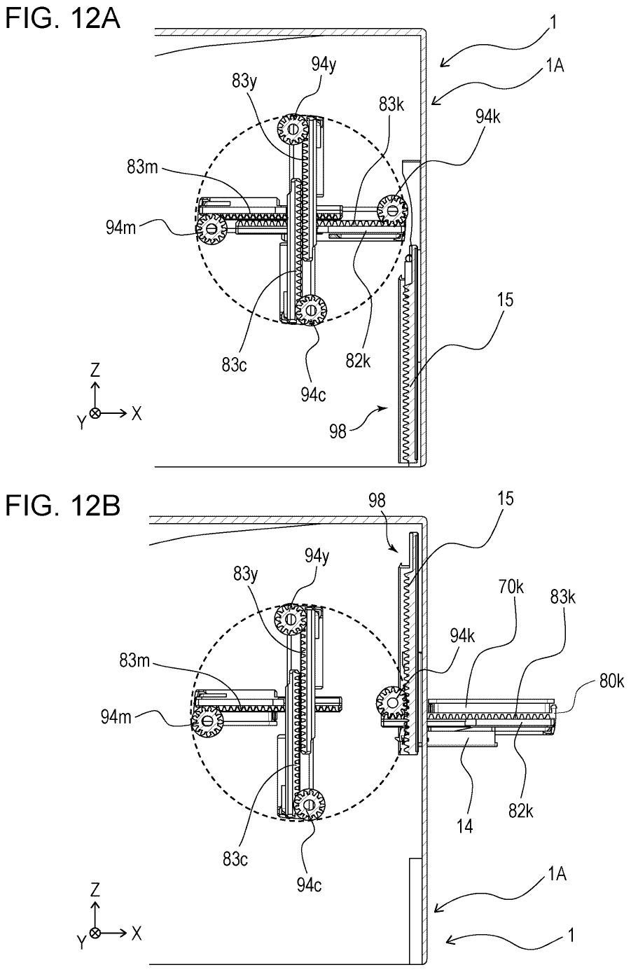

As illustrated in FIG. 12A described below, when viewed in the direction of the rotational axis 90C (Y direction), the rack part 83y overlaps the rack parts 83m and 83k. When viewed in the direction of the rotational axis 90C (Y direction), the rack part 83m overlaps the rack parts 83y and 83c. When viewed in the direction of the rotational axis 90C (Y direction), the rack part 83c overlaps the rack parts 83m and 83k. When viewed in the direction of the rotational axis 90C (Y direction), the rack part 83k overlaps the rack parts 83y and 83c. In other words, the region in which the first rack gear (rack part 83k) is disposed and the region in which the second rack gear (rack part 83y) is disposed do not overlap in the rotational axis direction of the rotary (Y direction). When viewed in the rotational axis direction of the rotary (Y direction), assuming that the first toner cartridge 70k is at the first attachment position and the second toner cartridge 70y is at the second attachment position, the first rack gear (rack part 83k) and the second rack gear (rack part 83y) overlap.

Thus, the position at which the rack parts 83k and 83m are disposed in the Y direction differs from the position at which the rack parts 83y and 83c are disposed. Therefore, when viewed in the Y direction, the rack parts 83y and 83c may be disposed to overlap the rack parts 83m and 83k.

Accordingly, the four trays may be arranged in a small space in the rotary body 90, and the radial size of the rotary body 90 can be reduced. If the rack parts 83 are disposed so as not to overlap when viewed in the Y direction while the moving distances of the trays 80y to 80k remain equivalent to those in the present embodiment, the area required to arrange the four rack parts is increased when viewed in the Y direction. In contrast to such a structure, when the rack parts 83 are shifted from each other in the Y direction so that the rack parts 83 overlap each other when viewed in the Y direction, the area of the region in which the rack parts 83 are disposed can be reduced when viewed in the Y direction.

In addition, in the present embodiment, the four rack parts 83y to 83k are grouped into two pairs that are shifted from each other in the Y direction. More specifically, in the rotational axis direction of the rotary (Y direction), the regions in which the first and second rack gears are disposed overlap, and the regions in which the third and fourth rack gears are disposed overlap. In addition, in the Y direction, the region in which the first and second rack gears are disposed and the region in which the third and fourth rack gears are disposed do not overlap. Thus, compared to when the four rack parts 83y to 83k are shifted from each other in the Y direction, the size of the rotary body 90 in the Y direction can be reduced.

### Structures for Moving Trays

The structures for moving the trays 80y to 80k arranged in the rotary body 90 will be described with reference to FIGS. 11A and 11B and FIGS. 12A and 12B. FIGS. 11A and 11B are perspective views illustrating the structure for moving the tray 80k. FIGS. 12A and 12B are sectional views illustrating the structure for moving the tray 80k.

In the present embodiment, the trays 80y to 80k are driven when the driving force of the motor M2 is transmitted to the pinion gears 94y to 94k by the drive racks 15L and 15R that serve as a transmission device. Here, the structure for moving the tray 80k relative to the rotary body 90 will be described. The structures for moving the trays 80y to 80c relative to the rotary body 90 are substantially similar to the structure for moving the tray 80k, and description thereof is thus omitted.

FIG. 11A illustrates a state in which the tray 80k is inside the rotary body 90 (that is, a state in which the toner cartridge 70k is attached to the developing unit 50k). In other words, FIG. 11A illustrates a state in which the tray 80k is at the accommodation position and in which the toner cartridge 70k is at the attachment position relative to the developing frame 53k (FIG. 4A). FIG. 11B illustrates a state in which the tray 80k has been slid out of the rotary body 90. In other words, FIG. 11B illustrates a state in which the tray 80k is at the removal position and in which the toner cartridge 70k is at the displaced position relative to the developing frame 53k (FIG. 4A).

The apparatus body 1A of the present embodiment includes the drive racks 15L and 15R as drive gears that drive the pinion gears 94. Each drive rack 15 is driven by the motor M2 through a transmission unit 15t. As illustrated in FIG. 11A, when the tray 80k is in the rotary body 90 (that is, when the toner cartridge 70k is attached to the developing unit 50k), the drive racks 15L and 15R are at disengaged positions at which the drive racks 15L and 15R are separated from the pinion gears 94k. The drive racks 15L and 15R move from the disengaged positions and engage with the pinion gears 94k so that the tray 80k moves from the accommodation position to the removal position and that the toner cartridge 70k moves from the attachment position to the displaced position.

As described above, two rack parts 83k are formed at the respective ends of the tray 80k in the Y direction. Two pinion gears 94k and two drive racks 15L and 15R are provided at positions corresponding to the rack parts 83k at the respective ends. More specifically, the apparatus body 1A of the present embodiment includes the drive racks 15L and 15R as first and second drive gears. The drive rack 15L is an example of a first drive gear, and the drive rack 15R is an example of a second drive gear.

These ordinal numbers are used for convenience of description, and are interchangeable in principle. The drive racks 15L and 15R are referred to as “drive racks 15” when it is not necessary to distinguish between the drive racks 15L and 15R.

The rack parts 83 of the present embodiment constitute a pair of rack gears, and the pinion gears 94 of the present embodiment constitute a pair of pinion gears. The rack gears and the pinion gears are disposed at one and the other ends of the support member (tray 80) in the Y direction in the present embodiment, but may be disposed at other positions. The rack parts 83k and the pinion gears 94k of the moving device 85k corresponding to the tray 80k may be regarded as examples of a first pair of rack gears and a first pair of pinion gears, respectively.

The rack parts 83y to 83c and the pinion gears 94y to 94c of the moving devices 85y to 85c corresponding to the outer trays 80y to 80c may be regarded as examples of a second pair of rack gears and a second pair of pinion gears.

One of the pair of rack gears meshes with one of the pair of pinion gears, and the other of the pair of rack gears meshes with the other of the pair of pinion gears. At least one of the pair of pinion gears is driven by the drive rack 15L that serves as the first drive rack. In the present embodiment, the pair of pinion gears are simultaneously driven by the drive racks 15L and 15R that serve as the first drive rack and the second drive rack, respectively. Thus, the tray 80 does not tend to rotate, and the toner cartridge 70 can be reliably moved. Alternatively, the tray 80 may be structured to include one rack part 83 and moved by one drive rack 15 through one pinion gear 94.

The tray 80k is held such that the tray 80k is slidable relative to the rotary body 90 in a direction parallel to the guided portions 82k (that is, in the movement direction Dk). The drive racks 15 are held such that the drive racks 15 are slidable relative to the apparatus body 1A in a direction crossing the movement direction Dk of the tray 80k. The drive racks 15 are configured to slide (reciprocate) relative to the apparatus body 1A in a first direction (vertically upward in the present embodiment) and in a second direction opposite to the first direction (vertically downward in the present embodiment). In other words, the movement direction of the drive racks 15 of the present embodiment is a direction crossing (or orthogonal to) both the movement direction Dk of the tray 80k and the direction of the rotational axis 90C of the rotary body 90 (Y direction).

A tray-moving operation in which the tray 80k is caused to slide between the accommodation position and the removal position will be described with reference to FIGS. 11A and 11B. The tray-moving operation of the tray 80k is carried out by the motor M2 (FIG. 2), the transmission unit 15t, the drive racks 15, the pinion gears 94k, and the rack parts 83k.

The tray-moving operation for removing the toner cartridge 70k from the rotary body 90 (tray-drawing operation) will now be described. Before the tray-drawing operation is started, the drive racks 15 are positioned below the position at which the drive racks 15 mesh with the pinion gears 94k (FIG. 11A).

In addition, as described above, the rotary body 90 is in the replacement position for the toner cartridge 70k (FIG. 4B) when the toner cartridge 70k is to be replaced.

When the tray-drawing operation is started, the drive racks 15 are caused to slide upward relative to the apparatus body 1A by the driving force of the motor M2. The drive racks 15 move to become engaged with the pinion gears 94k, so that the pinion gears 94k are rotationally driven.

As illustrated in FIG. 11B, the pinion gears 94k are rotationally driven in the direction shown by the arrows, so that the driving force is applied to the rack parts 83k that mesh with the pinion gears 94k. Accordingly, the tray 80k is pushed to the outside space and moves relative to the rotary body 90 from the accommodation position to the removal position. At this time, the tray 80k is guided to move in the predetermined movement direction Dk due to the engagement between the guided portions 82k and the guiding portions 97k (FIG. 7A) of the rotary body 90.

As a result of the tray 80k moving from the accommodation position to the removal position, the toner cartridge 70k is moved relative to the developing unit 50k from the attachment position to the displaced position.

When the tray 80k is at the removal position and the toner cartridge 70k is at the displaced position, the user can attach and remove the toner cartridge 70k to/from the tray 80k.

The procedure of the tray-moving operation for attaching the toner cartridge 70 to the rotary body 90 (tray-retracting operation, tray insertion operation) is the reverse of that of the tray-drawing operation. For example, the user operates a predetermined operation member to start the tray-retracting operation. When the tray-retracting operation is started, the drive racks 15 are caused to slide downward relative to the apparatus body 1A by the driving force of the motor M2. Here, the rotation direction of the motor M2 in the tray-retracting operation is opposite to that in the tray-drawing operation.

When the pinion gears 94k are rotationally driven in the direction opposite to the direction shown by the arrows in FIG. 11B, the driving force is applied to the rack parts 83k that mesh with the pinion gears 94k. Accordingly, the tray 80k is retracted and moves relative to the rotary body 90 from the removal position to the accommodation position.

The tray 80k is guided to move in the movement direction Dk (direction opposite to the direction shown by the arrow in FIG. 11B) due to the engagement between the guided portions 82k and the guiding portions 97k (FIG. 7A) of the rotary body 90. As a result of the tray 80k moving from the removal position to the accommodation position, the toner cartridge 70k is moved relative to the developing unit 50k from the displaced position to the attachment position.

Although the movement of the black tray 80k and the toner cartridge 70k has been described, the other trays 80y to 80c and the other toner cartridges 70y to 70c are also moved by similar structures. More specifically, the drive racks 15 transmit the driving force to the pinion gears 94y to 94c at the replacement position for each toner cartridge.

The motor M2 provided in the apparatus body 1A and the transmission device including the drive racks 15 (15L and 15R) and the transmission unit 15t constitute the driving device 98 for driving the moving devices 85 provided in the rotary body 90.

As described above, in the present embodiment, the rotary body 90 is provided with the moving devices 85y to 85k corresponding to the toner cartridges 70y to 70k. The driving device 98 of the apparatus body 1A is a shared driving device that drives the moving devices 85y to 85k (a plurality of driven devices) of the rotary body 90.

In addition, in the present embodiment, the rotary body 90 rotates to change the object to be driven by the driving device 98. In other words, the driving device of the present embodiment includes the drive racks 15 that serve as the transmission members that transmit the driving force of the drive source. The driving device may be set to a state in which the transmission members engage with the first driven unit (pinion gears 94k) to enable transmission of the driving force and a state in which the transmission members engage with the second driven unit (pinion gears 94m) to enable transmission of the driving force. In addition, the driving device may also be set to the state in which the transmission members are separated from the first driven unit and the second driven unit.

As described above, the pinion gears 94y to 94k are held by the rotary body 90. Therefore, when the rotary body 90 rotates, the pinion gears 94y to 94k may be disengaged from the drive racks 15.

FIG. 12A illustrates a state in which the tray 80k is inside the rotary body 90 (at the accommodation position). FIG. 12B illustrates a state in which the tray 80k has been moved out of the rotary body 90 (moved to the removal position).

As illustrated in FIG. 12A, when the tray 80k is inside the rotary body 90, each drive rack 15 is positioned in a lower section of the apparatus body 1A. In this state, each drive rack 15 is separated from the corresponding pinion gear 94k. Therefore, the rotary body 90 can be rotated without being impeded by the drive rack 15. More specifically, the drive rack 15 can be disposed outside the rotational trajectory of the rotary body 90 shown by the dotted line in FIGS. 12A and 12B.

As described above, each tray 80 attached to the rotary body 90 is movable relative to the rotary body 90 from the accommodation position to the removal position and from the removal position to the accommodation position by rotationally driving the motor M2 in forward and reverse directions. In other words, the driving device of the present embodiment is capable of driving each moving device of the rotary not only to move the corresponding toner cartridge from the attachment position to the displaced position but also to move the corresponding toner cartridge from the displaced position to the attachment position.

As described above, in the present embodiment, the amount by which each tray 80 is moved when the corresponding toner cartridge 70 is to be replaced is changed depending on the size of the toner cartridge 70. More specifically, as illustrated in FIGS. 7A and 7B, the distance L1 by which the black tray 80k is moved from the accommodation position to the removal position is greater than the distance L2 by which the other trays 80y to 80c are moved from the accommodation position to the removal position.

Therefore, in the present embodiment, when the toner cartridges 70y to 70k are moved from the attachment position to the displaced position, the value obtained by dividing the velocity of the rack parts 83k by the velocity of the drive racks 15 is greater than the value obtained by dividing the velocity of the rack parts 83y to 83c by the velocity of the drive racks 15.

For example, as illustrated in FIG. 10, each pinion gear 94y is composed of a multistage gear formed such that a pitch-circle radius of a small-diameter gear 942 meshing with the corresponding rack part 83y is less than a pitch-circle radius of a large-diameter gear 941 meshing with the corresponding drive rack 15. The pinion gears 94m and 94c are composed of similar multistage gears. In contrast, each pinion gear 94k is formed such that a portion meshing with the corresponding drive rack 15 and a portion meshing with the corresponding rack part 83k have the same pitch-circle radius. In this case, the pitch-circle radius of the pinion gear 94k may be equal to the pitch-circle radius of the large-diameter gears 941 of the pinion gears 94y to 94c.

According to this structure, even when the movement distance of the drive racks 15 is constant, the rack parts 83k may be moved by a distance greater than the distance by which the other rack parts 83y to 83c are moved. In other words, the black tray 80k may be moved from the accommodation position to the removal position by the movement distance L1 greater than the movement distance L2 by which the other trays 80y to 80c are moved from the accommodation position to the removal position.

In addition, since the pinion gears 94y to 94c are composed of multistage gears, although the pinion gears 94y to 94k receive the driving force from the same drive racks 15, the tray 80k can be moved by the movement distance L1 greater than the movement distance L2 by which the trays 80y to 80c are moved.

Instead of (or in addition to) using multistage gears as the pinion gears 94y to 94c, each pinion gear 94k may be composed of a multistage gear. In such a case, a portion of each pinion gear 94k meshing with the corresponding drive rack 15 may be formed as a small-diameter gear, and a portion of the pinion gear 94k meshing with the corresponding rack part 83k may be formed as a large-diameter gear having a pitch-circle radius greater than that of the small-diameter gear. The multistage gear is an example of a speed reduction mechanism, and may be replaced by a known speed reduction mechanism in which an amount of movement of an output-side (tray-80-side) member is less than an amount of movement of an input-side (drive-source-side) member.

Alternatively, the amount by which the drive racks 15 are moved to move the toner cartridge 70k from the attachment position to the displaced position may be greater than the amount by which the drive racks 15 are moved to move toner cartridges 70y to 70c from the attachment position to the displaced position.

As the distance by which each toner cartridge 70 is moved from the attachment position to the displaced position decreases, the toner cartridge 70 can be moved in a shorter time, and the time for which the user needs to wait for the movement of the toner cartridge 70 can be reduced. When the amount of movement of the drive racks 15 for the toner cartridge 70k is greater than the amount of movement of the drive racks 15 for the toner cartridges 70y to 70c, the time for which the user needs to wait for the movement of the toner cartridges 70y to 70c can be reduced.

According to the above-described structures, the movement distance L1 can be set to a distance greater than the movement distance L2. These structures may be applied in combination.

### Positional Relationship Between Scanner, Intermediate Transfer Unit, Cleaning Unit, and Rotary Body

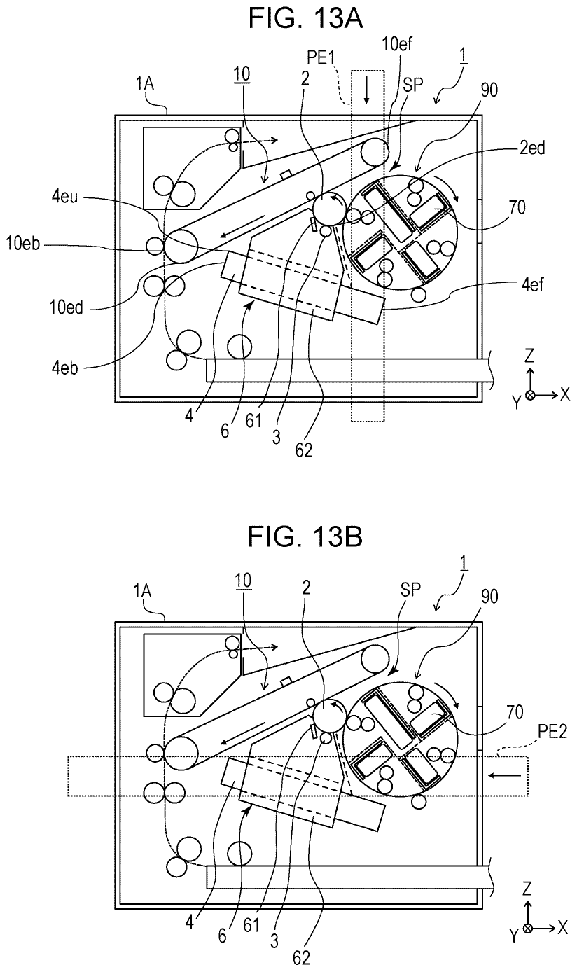

The positional relationship between the scanner 4, the intermediate transfer unit 10, the cleaning unit 6, and the rotary body 90 will now be described with reference to FIGS. 13A and 13B. FIGS. 13A and 13B are sectional views illustrating a cross-section of the image forming apparatus 1.

As illustrated in FIGS. 13A and 13B, the cleaning unit 6 includes the cleaning blade 61 and the waste-toner-receiving unit 62. The cleaning blade 61 serves as a collecting member that collects waste toner remaining on the photosensitive drum 2 after the toner image is transferred from the photosensitive drum 2. The waste-toner-receiving unit 62 receives the waste toner removed from the surface of the photosensitive drum 2 by the cleaning blade 61.

The cleaning blade 61 is made of, for example, urethane rubber, and scrapes off the waste toner on the surface of the photosensitive drum 2 with an edge of the cleaning blade 61. The material and shape of the cleaning blade 61 are not particularly limited, and the cleaning blade 61 may be formed of, for example, a sponge or a brush.

The rotary body 90, the photosensitive drum 2, the charging roller 3, and the cleaning blade 61 are disposed in a space SP between the intermediate transfer unit 10 and the scanner 4 in the direction of gravity, that is, in a direction opposite to the Z direction (−Z direction). As shown in a region PE1 surrounded by the dashed lines in FIG. 13A, when viewed in the −Z direction, the intermediate transfer unit, the rotary body 90, and the scanner 4 partially overlap, and the intermediate transfer unit 10, the rotary body 90, and the scanner 4 are arranged in that order in the −Z direction.

As shown in a region PE2 surrounded by the dashed lines in FIG. 13B, when viewed in the −X direction, the rotary body 90, the scanner 4, and the intermediate transfer unit 10 partially overlap, and the rotary body 90, the scanner 4, and the intermediate transfer unit 10 are arranged in that order in the −X direction. When the scanner 4, the intermediate transfer unit 10, the cleaning unit 6, and the rotary body 90 are arranged as described above, the size of the image forming apparatus 1 can be reduced. In addition, the toner cartridges 70 attached to the rotary body 90 can be easily replaced from the front of the apparatus body 1A.

### Positional Relationship Between Scanner and Waste-Toner-Receiving Unit

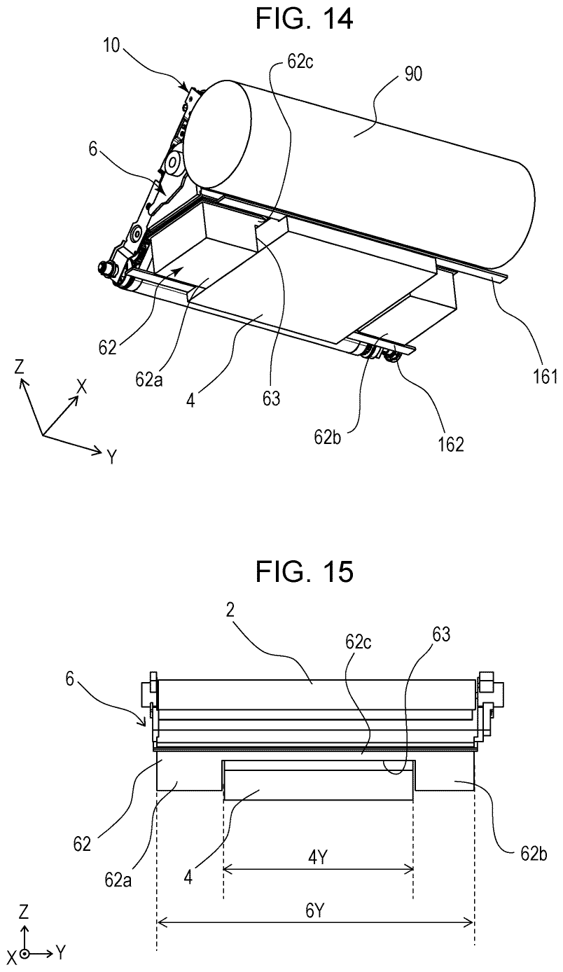

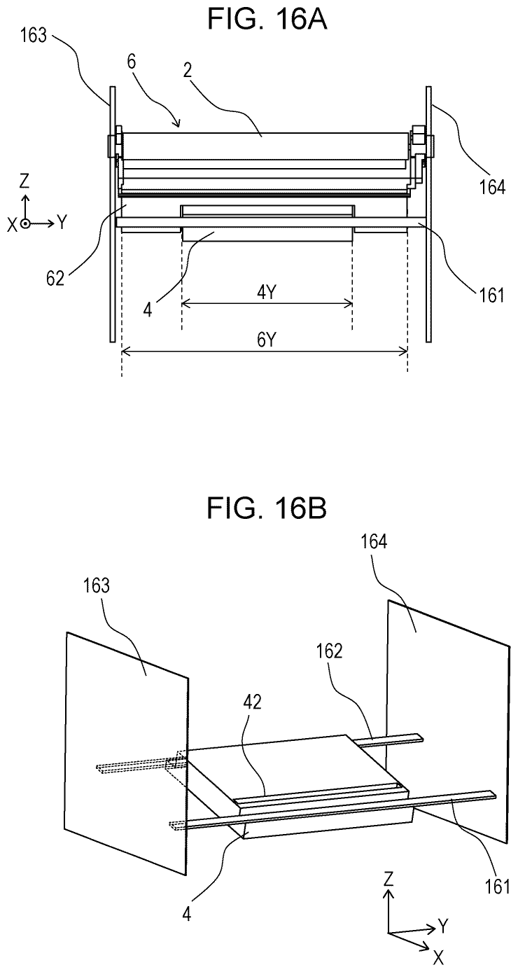

The positional relationship between the scanner 4 and the waste-toner-receiving unit 62 will be described with reference to FIGS. 13A to 16B. FIG. 14 is a perspective view of the intermediate transfer unit 10, the cleaning unit 6, and the scanner 4. FIG. 15 is a front view of the cleaning unit 6 and the scanner 4. FIG. 16A is a front view of a support structure for the scanner 4. FIG. 16B is a perspective view of the support structure for the scanner 4.

As illustrated in FIGS. 13A to 15, the cleaning unit 6 is disposed adjacent to the photosensitive drum 2. The waste-toner-receiving unit 62 of the cleaning unit 6 includes a first waste-toner-receiving chamber 62a and a second waste-toner-receiving chamber 62b disposed at a position different from the position of the first waste-toner-receiving chamber 62a in the Y direction. The waste-toner-receiving unit 62 also includes a connecting chamber 62c that connects the first waste-toner-receiving chamber 62a and the second waste-toner-receiving chamber 62b. The first waste-toner-receiving chamber 62a, the second waste-toner-receiving chamber 62b, and the connecting chamber 62c are all capable of receiving the waste toner.

The toner removed from the photosensitive drum 2 by the cleaning blade 61 is transported from a position close to the cleaning blade 61 to the waste-toner-receiving unit 62 by gravity or the operation of a transport screw (not illustrated). When viewed in the −Z direction, the waste-toner-receiving unit 62 is disposed such that at least a portion thereof overlaps the scanner 4. In addition, when viewed in the Y direction, the waste-toner-receiving unit 62 is disposed such that at least a portion thereof overlaps the scanner 4.

More specifically, the first waste-toner-receiving chamber 62a and the second waste-toner-receiving chamber 62b are disposed such that at least portions thereof overlap the scanner 4 when viewed in the Y direction. In addition, the connecting chamber 62c is disposed to overlap the scanner 4 along the Y direction. In the present embodiment, the connecting chamber 62c is disposed such that the connecting chamber 62c does not overlap the scanner 4 when viewed in the Y direction. However, the connecting chamber 62c is not limited to this. For example, the connecting chamber 62c may be disposed such that a portion thereof overlaps the scanner 4 when viewed in the Y direction.

As illustrated in FIG. 15, a length 4Y of the scanner 4 in the Y direction is shorter than a length 6Y of the waste-toner-receiving unit 62 in the Y direction. In addition, the scanner 4 is disposed in a recess 63 defined by the first waste-toner-receiving chamber 62a, the second waste-toner-receiving chamber 62b, and the connecting chamber 62c.

As illustrated in FIGS. 16A and 16B, the apparatus body 1A (FIG. 1) includes side plates 163 and 164 that are portions of the frame of the apparatus body 1A. The side plates 163 and 164 extend along XZ planes, and are spaced from each other in the Y direction. The side plates 163 and 164 support the photosensitive drum 2 in a rotatable manner. The side plates 163 and 164 are connected to each other by support stays 161 and 162 extending in the Y direction. The support stays 161 and 162 support the scanner 4.

Since the waste-toner-receiving unit 62 is disposed such that at least a portion thereof overlaps the scanner 4 when viewed in the Y direction as described above, the size of the image forming apparatus 1 can be reduced in the Z and X directions. In addition, the capacity of the waste-toner-receiving unit 62 can be increased without increasing the size of the image forming apparatus 1.

When, for example, the waste-toner-receiving unit 62 is completely filled with toner, there is a risk that the toner removed from the photosensitive drum 2 by the cleaning blade 61 will scatter in the apparatus body 1A. Therefore, the user needs to replace the cleaning unit 6 or remove the toner in the waste-toner-receiving unit 62 before the waste-toner-receiving unit 62 is completely filled with toner. In the present embodiment, since the capacity of the waste-toner-receiving unit 62 can be increased without increasing the size of the image forming apparatus 1, the frequency of maintenance of the waste-toner-receiving unit 62 can be reduced.

### First Modification

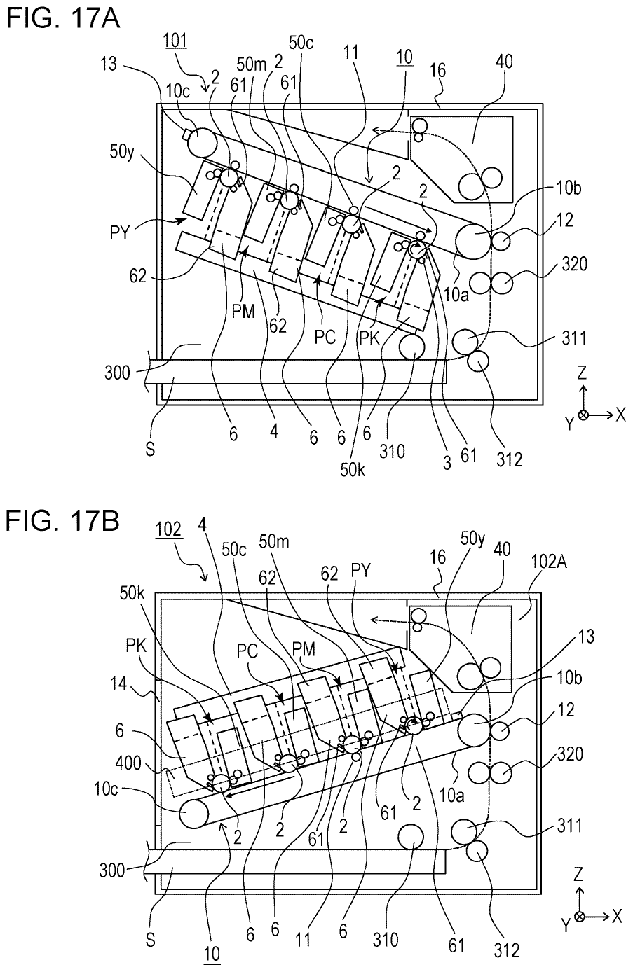

FIG. 17A is a sectional view of an image forming apparatus 101 according to a first modification of the present embodiment. In the first modification, elements similar to those of the present embodiment are not illustrated, or are denoted by the same reference signs as those in the present embodiment in the figures. The image forming apparatus 101 according to the first modification is not of a rotary type, but is a tandem laser beam printer. More specifically, as illustrated in FIG. 17A, the image forming apparatus 101 includes four process cartridges PY, PM, PC, and PK instead of the rotary unit 90U, the photosensitive drum 2, and the cleaning unit 6 according to the above-described embodiment. These process cartridges form yellow, magenta, cyan, and black toner images. Each process cartridge includes a photosensitive drum 2, a developing unit 50, and a cleaning unit 6. The toner images formed on the photosensitive drums 2 of the process cartridges are transferred to an intermediate transfer belt 10a in a superposed manner.

For example, the process cartridge PY, which serves as a first processing unit, includes the photosensitive drum 2 as a first photosensitive drum; a first developing unit 50y that develops a first electrostatic latent image formed on the photosensitive drum 2 into a first toner image; and the cleaning unit 6. The cleaning unit 6 includes a cleaning blade 61 as a first collecting member and a waste-toner-receiving unit 62 as a first waste-toner-receiving unit. The cleaning blade 61 collects waste toner remaining on the photosensitive drum 2 after the first toner image is transferred from the photosensitive drum 2. The waste-toner-receiving unit 62 receives the waste toner collected by the cleaning blade 61. The process cartridge PM, which serves as a second processing unit, includes the photosensitive drum 2 as a second photosensitive drum; a second developing unit 50m that develops a second electrostatic latent image formed on the photosensitive drum 2 into a second toner image; and the cleaning unit 6. The cleaning unit 6 includes a cleaning blade 61 as a second collecting member and a waste-toner-receiving unit 62 as a second waste-toner-receiving unit. The cleaning blade 61 collects waste toner remaining on the photosensitive drum 2 after the second toner image is transferred from the photosensitive drum 2. The waste-toner-receiving unit 62 receives the waste toner collected by the cleaning blade 61.

The developing units 50y, 50m, 50c, and 50k are removably attachable to and supported by side plates 163 and 164 (see FIGS. 16A and 16B), and are capable of being inserted and extracted through an opening formed in the side plate 163 on the −Y side. The developing units 50y, 50m, 50c, and 50k may be inserted and extracted together with the process cartridges PY, PM, PC, and PK, respectively.

In the first modification, the intermediate transfer unit 10 is disposed above the process cartridges PY, PM, PC, and PK and the scanner 4. The waste-toner-receiving unit (62) of each of the process cartridges PY, PM, PC, and PK is disposed such that at least a portion thereof overlaps the scanner 4 when viewed in the Y direction. Accordingly, effects similar to those of the present embodiment can be obtained.

### Second Modification

FIG. 17B is a sectional view of an image forming apparatus 102 according to a second modification of the present embodiment. In the second modification, elements similar to those of the first modification are not illustrated, or are denoted by the same reference signs as those in the first modification in the figures. Similarly to the first modification, the image forming apparatus 102 according to the second modification is a tandem laser beam printer. More specifically, as illustrated in FIG. 17B, the image forming apparatus 102 includes four process cartridges PY, PM, PC, and PK. In the second modification, the intermediate transfer unit 10 is disposed below the process cartridges PY, PM, PC, and PK and the scanner 4.

The process cartridges PY, PM, PC, and PK are supported by a drawer unit 400. The drawer unit 400 are supported such that the drawer unit 400 is capable of being drawn out of an apparatus body 102A of the image forming apparatus 102 in the −X direction. The apparatus body 102A includes a door 14 capable of being opened and closed on a −X-side surface thereof. When the door 14 is open, the drawer unit 400 can be drawn out of the apparatus body 102A in the −X direction. When the drawer unit 400 is drawn out of the apparatus body 102A, the process cartridges PY, PM, PC, and PK are attachable to and removable from the drawer unit 400.

Also in this modification, the waste-toner-receiving unit (62) of each of the process cartridges PY, PM, PC, and PK is disposed such that at least a portion thereof overlaps the scanner 4 when viewed in the Y direction. Accordingly, effects similar to those of the present embodiment can be obtained.

### Positional Relationship Between Passage Section of Scanner and Discharge Opening in Toner Cartridge

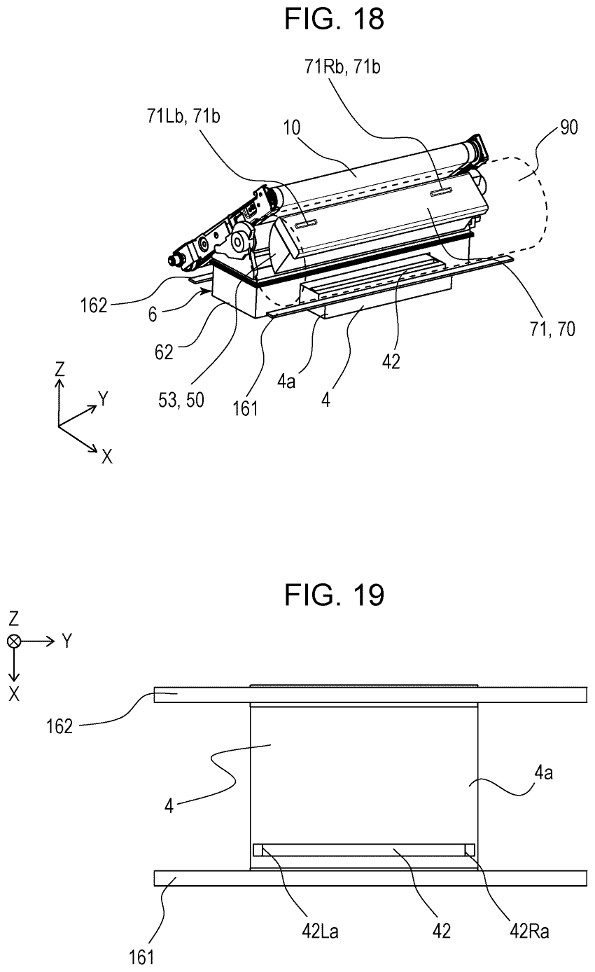

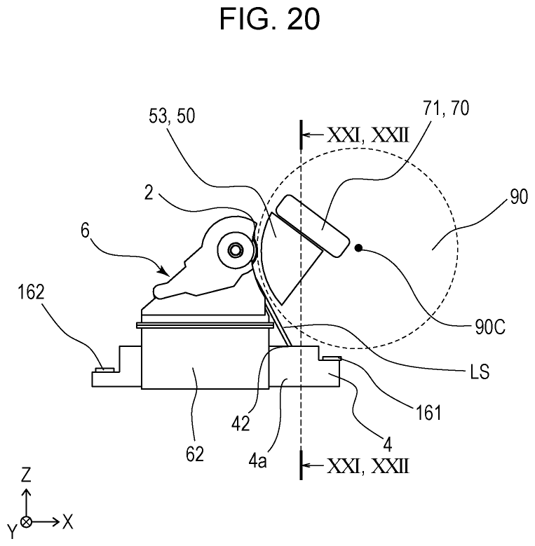

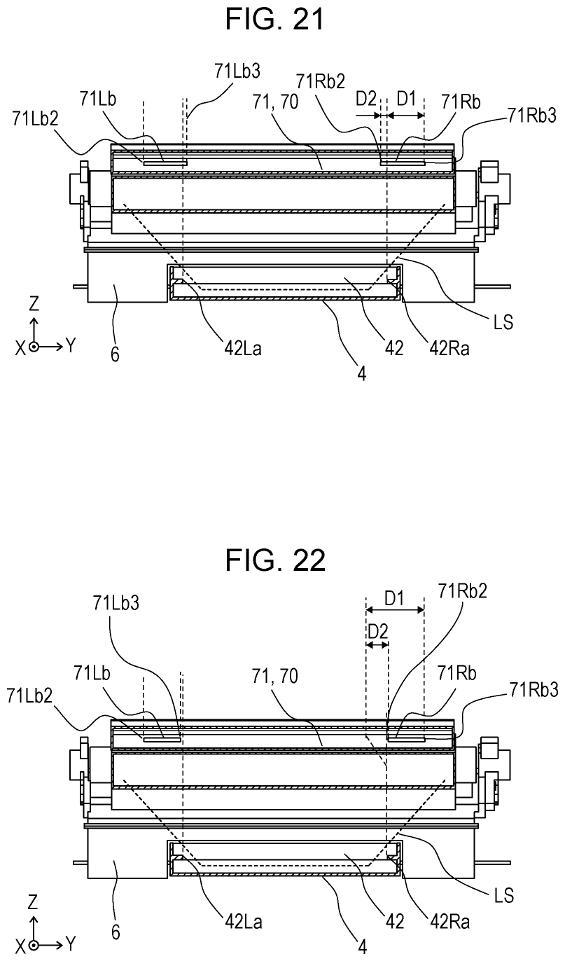

The positional relationship between a passage section 42 of the scanner 4 and discharge openings 71b in each toner cartridge 70 will be described with reference to FIGS. 18 to 21. FIG. 18 is a perspective view of the scanner 4 and the toner cartridge 70. FIG. 19 is a plan view of the passage section 42 of the scanner 4. FIG. 20 is a side view of the scanner 4 and the toner cartridge 70. FIG. 21 is a sectional view taken along line XXI, XXII-XXI, XXII in FIG. 20.

As illustrated in FIGS. 3 and 18, the toner frame 71 of each toner cartridge 70 has the discharge openings 71b. The developing frame 53 of each developing unit 50 has receiving openings 53b that face the discharge openings 71b. The discharge openings 71b are examples of toner outlets through which the toner is supplied to the developing-device storage unit 53a in the developing frame 53. In the present embodiment, two discharge openings 71b are formed in the toner cartridge 70 at different positions in the Y direction. In the following description, the discharge opening 71b on the +Y side is referred to as a discharge opening 71Rb, and the discharge opening 71b on the −Y side is referred to as a discharge opening 71Lb.

As illustrated in FIGS. 18 to 20, the scanner 4 includes a scanner housing 4a, which serves as a housing, and a passage section 42 provided on the scanner housing 4a. Laser light LS, which serves as light emitted toward the photosensitive drum 2, passes through the passage section 42. The scanner 4 includes a laser oscillation unit (not illustrated) that is disposed in the scanner housing 4a and that oscillates the laser light LS.

The passage section 42 is disposed below the rotational axis 90C of the rotary body 90. In the present embodiment, the passage section 42 is an opening formed in the scanner housing 4a in the present embodiment. However, the passage section 42 is not limited to this. For example, the passage section 42 may be a transparent portion that allows the laser light LS to pass therethrough. A portion of the scanner housing 4a other than the passage section 42 is formed of a member that does not transmit laser light.

As illustrated in FIG. 19, the passage section 42 extends in the Y direction. The passage section 42 has a downstream end 42Ra and an upstream end 42La in the Y direction. The Y direction, which is an example of a predetermined direction, may be regarded as a direction from one side (−Y side) toward the other side (+Y side) in the rotational axis direction of the rotary body 90.

As illustrated in FIG. 21, the discharge openings 71Rb and 71Lb extend in the Y direction. The discharge opening 71Rb, which serves as a first toner outlet, has a downstream end 71Rb3 and an upstream end 71Rb2 in the Y direction. The downstream end 71Rb3 is positioned farther from the center of the toner image formed on the photosensitive drum 2 than the upstream end 71Rb2 in the Y direction. Similarly, the discharge opening 71Lb, which serves as a second toner outlet, has a downstream end 71Lb3 and an upstream end 71Lb2 in the Y direction. The upstream end 71Lb2 is positioned farther from the center of the toner image formed on the photosensitive drum 2 than the downstream end 71Lb3 in the Y direction.

The downstream end 71Rb3 of the discharge opening 71Rb is positioned downstream of the downstream end 42Ra of the passage section 42 in the Y direction. In addition, in the present embodiment, the upstream end 71Rb2 of the discharge opening 71Rb is positioned upstream of the downstream end 42Ra of the passage section 42 in the Y direction. The upstream end 71Lb2 of the discharge opening 71Lb is positioned upstream of the upstream end 42La of the passage section 42 in the Y direction. In addition, in the present embodiment, the downstream end 71Lb3 of the discharge opening 71Lb is positioned downstream of the upstream end 42La of the passage section 42 in the Y direction. A distance D1 between the downstream end 71Rb3 of the discharge opening 71Rb and the downstream end 42Ra of the passage section 42 is greater than a distance D2 between the upstream end 71Rb2 of the discharge opening 71Rb and the downstream end 42Ra of the passage section 42 in the Y direction.

As described above, in the present embodiment, the discharge openings 71Rb and 71Lb are positioned such that at least portions thereof do not overlap the passage section 42 of the scanner 4 in the Y direction. More specifically, the downstream end 71Rb3 of the discharge opening 71Rb is positioned downstream of the downstream end 42Ra of the passage section 42 in the Y direction, and the upstream end 71Lb2 of the discharge opening 71Lb is positioned upstream of the upstream end 42La of the passage section 42 in the Y direction. Therefore, even when the toner falls through the spaces between each discharge opening 71b and the corresponding receiving opening 53b, the amount of toner that falls to the passage section 42 of the scanner 4 can be reduced. Therefore, when the passage section 42 is an opening, the amount of toner that enters the scanner housing 4a of the scanner 4 can be reduced, so that performance degradation of the scanner 4 can be suppressed. In addition, when the passage section 42 is a transparent portion, the amount of toner that adheres to the passage section 42 can be reduced, so that performance degradation of the scanner 4 can be suppressed.

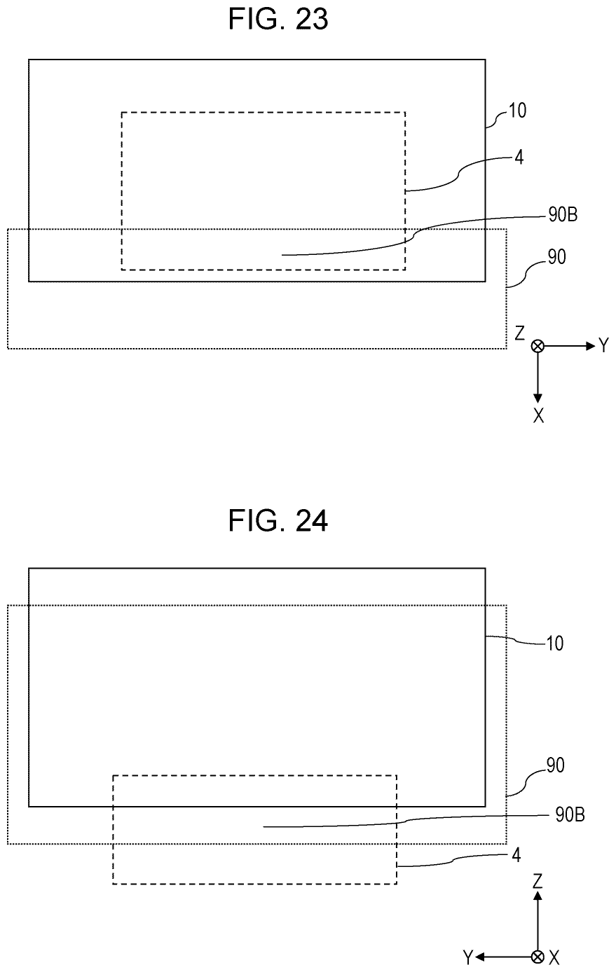

The positional relationship between the intermediate transfer unit 10, the rotary body 90, and the scanner 4 will now be described with reference to FIGS. 13, 23, and 24. FIGS. 23 and 24 are plan views of the intermediate transfer unit 10, the rotary body 90, and the scanner 4.

As illustrated in FIG. 23, when viewed in the vertical direction, the intermediate transfer unit 10, a portion 90B of the rotary body, and the scanner 4 overlap. According to this structure, the size of the image forming apparatus 1 in the X direction can be reduced. In addition, as illustrated in FIG. 13, the portion 90B of the rotary body 90 is disposed above the scanner 4 and below the intermediate transfer unit 10.

In the following description, the direction in which each toner cartridge 70 moves from the attachment position to the displaced position is referred to as a displacement direction.

As illustrated in FIG. 24, when viewed in the displacement direction, the intermediate transfer unit 10 overlaps a portion of the rotary body 90 and the scanner 4. According to this structure, the size of the image forming apparatus 1 in the Z direction can be reduced.

As illustrated in FIG. 13A, a bottom end of the intermediate transfer unit 10 is referred to as an end 10ed. A top end of the scanner 4 is referred to as an end 4eu. The end 10ed is below the end 4eu.

As illustrated in FIG. 13A, a downstream end of the scanner 4 in the displacement direction is referred to as an end 4ef. In addition, an upstream end of the scanner 4 in the displacement direction is referred to as an end 4eb. The end 4ef is below the end 4eb.

As illustrated in FIG. 13A, a downstream end of the intermediate transfer unit 10 in the displacement direction is referred to as an end 10ef. In addition, an upstream end of the intermediate transfer unit 10 in the displacement direction is referred to as an end 10eb. The end 10ef is above the end 10eb.

In addition, as illustrated in FIG. 13A, a bottom end of the photosensitive drum 2 is referred to as an end 2ed. The end 10ed is below the end 2ed.

### Second Embodiment

An image forming apparatus according to a second embodiment will now be described. The second embodiment differs from the first embodiment in the positional relationship between the passage section 42 of the scanner 4 and the discharge openings 71b of the toner cartridge 70. Therefore, elements similar to those of the first embodiment are not illustrated, or are denoted by the same reference signs as those in the first embodiment in the figures. FIG. 22 is a sectional view taken along line XXI, XXII-XXI, XXII in FIG. 20 according to the second embodiment.

In the second embodiment, as illustrated in FIG. 22, the downstream end 71Rb3 and the upstream end 71Rb2 of the discharge opening 71Rb are positioned downstream of the downstream end 42Ra of the passage section 42. In addition, the downstream end 71Lb3 and the upstream end 71Lb2 of the discharge opening 71Lb are positioned upstream of the upstream end 42La of the passage section 42. In other words, in the present embodiment, the entirety of the discharge opening 71Rb is positioned downstream of the downstream end 42Ra of the passage section 42. In addition, the entirety of the discharge opening 71Lb is positioned upstream of the upstream end 42La of the passage section 42. In addition, also in the present embodiment, the distance D1 between the downstream end 71Rb3 of the discharge opening 71Rb and the downstream end 42Ra of the passage section 42 is greater than the distance D2 between the upstream end 71Rb2 of the discharge opening 71Rb and the downstream end 42Ra of the passage section 42 in the Y direction.

As described above, in the present embodiment, the discharge openings 71Rb and 71Lb are disposed such that the entireties thereof do not overlap the passage section 42 of the scanner 4 in the Y direction. Therefore, even when the toner falls through the spaces between each discharge opening 71b and the corresponding receiving opening 53b, the amount of toner that falls to the passage section 42 of the scanner 4 can be reduced. Therefore, performance degradation of the scanner 4 can be more reliably suppressed.

### Other Embodiments

In the above-described first and second embodiments, the waste-toner-receiving unit 62 includes the first waste-toner-receiving chamber 62a, the second waste-toner-receiving chamber 62b, and the connecting chamber 62c, and the scanner 4 is disposed in the recess 63 in the waste-toner-receiving unit 62. However, the waste-toner-receiving unit 62 is not limited to this. For example, the waste-toner-receiving unit 62 does not necessarily have the recess 63. In such a case, for example, the waste-toner-receiving unit 62 may be disposed such that the waste-toner-receiving unit 62 overlaps at least a portion of the scanner 4 when viewed in the Y direction and is offset from the scanner 4 in the Y direction. Thus, the shape and material of the waste-toner-receiving unit 62 are not limited as long as the waste-toner-receiving unit 62 is disposed such that at least a portion thereof overlaps the scanner 4 when viewed in the Y direction.

In the present embodiment, the toner cartridge 70 has two discharge openings 71Rb and 71Lb. However, the toner cartridge 70 is not limited to this. For example, the number of discharge openings (71b) formed in the toner cartridge 70 may be one or three or more.

In addition, in the above-described first and second embodiments, the rotary body 90 includes the four developing units 50y to 50k, and a color image can be formed using the toners of four colors. However, the rotary body 90 may include three or less developing units, or five or more developing units. In these cases, the number and arrangement of trays and toner cartridges may be changed in accordance with the number of developing units. For example, in the above-described first and second embodiment, the four toner cartridges 70y to 70k are removably attachable to the rotary body 90. However, the rotary body 90 may include only one developing unit 50k, and one toner cartridge 70k may be attached to the rotary body 90. In this case, the rotary body 90 may rotate clockwise around the rotational axis 90C in FIG. 1 to alternately reach the black replacement position and the black developing position.

In addition, in the above-described first and second embodiments, the rotary body 90 includes the four developing units 50y to 50k, and a color image can be formed using the toners of four colors. However, the rotary body 90 may include a plurality of developing units capable of forming an image using toner of one color. For example, the rotary body 90 may include four black developing units 50k, and four toner cartridges 70k may be attached to the rotary body 90.

The present disclosure provides a new type of image forming apparatus developed from the related art.

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-070505 filed Apr. 24, 2024, which is hereby incorporated by reference herein in its entirety.

What is claimed is:

1. An image forming apparatus to which a cartridge that stores developer is removably attachable, the image forming apparatus comprising:
a photosensitive member;
an exposure device that irradiates a surface of the photosensitive member with light to form an electrostatic latent image on the surface;
a rotary that is rotatable and includes
a storage unit configured to store the developer supplied from the cartridge, and
a developing member that forms a developer image on the photosensitive member using the developer stored in the storage unit;
a moving device that moves the cartridge between an attachment position at which the cartridge is positioned inside the rotary and a displaced position at which the cartridge is positioned outside the rotary; and
an intermediate transfer unit to which the developer image on the photosensitive member is transferred,
wherein, when viewed in a vertical direction, the intermediate transfer unit, a portion of the rotary, and the exposure device overlap, and
wherein, when viewed in a displacement direction in which the cartridge moves from the attachment position to the displaced position, the intermediate transfer unit, the exposure device, and the portion of the rotary overlap.

2. The image forming apparatus according to claim 1,
wherein the portion of the rotary is above the exposure device and below the intermediate transfer unit.

3. The image forming apparatus according to claim 2,
wherein, when viewed in the displacement direction, the intermediate transfer unit overlaps the portion of the rotary and the exposure device.

4. The image forming apparatus according to claim 3,
wherein a bottom end of the intermediate transfer unit is below a top end of the exposure device.

5. The image forming apparatus according to claim 4,
wherein a downstream end of the exposure device in the displacement direction is below an upstream end of the exposure device in the displacement direction.

6. The image forming apparatus according to claim 5,
wherein a downstream end of the intermediate transfer unit in the displacement direction is above an upstream end of the intermediate transfer unit in the displacement direction.

7. The image forming apparatus according to claim 6,
wherein the bottom end of the intermediate transfer unit is below a bottom end of the photosensitive member.
